(19) United States
(12) Patent Application Publication
(10) Pub. No.: US 2024/0416314 A1
(43) Pub. Date: Dec. 19, 2024

(54) MULTIPLE CYLINDERS

(71) Applicants: BASF SE, Ludwigshafen am Rhein (DE); Linde GmbH, Pullach (DE)

(72) Inventors: Kiara Aenne KOCHENDOERFER, Ludwigshafen am Rhein (DE); Andrey SHUSTOV, Ludwigshafen am Rhein (DE); Eric JENNE, Ludwigshafen am Rhein (DE)

(21) Appl. No.: 18/695,027

(22) PCT Filed: Sep. 26, 2022
(86) PCT No.: PCT/EP2022/076624

§ 371 Date: Mar. 25, 2024

(30) Foreign Application Priority Data
Sep. 27, 2021 (EP) 21199084.1

(51) Int. Cl. B01J 19/00; B01J 19/24; H05B 1/02

(52) U.S. Cl. CPC B01J 19/0013; B01J 19/2415; H05B 1/023; B01J 2219/00135; B01J 2219/00155

(57) ABSTRACT

A device (110) comprising a multitude of hollow cylinder pipes is proposed. At least one of the hollow cylinder pipes is set up as a fluid cylinder (112) to receive at least one feedstock. At least one further hollow cylinder pipe is configured as a current-conducting heating cylinder (129). The device (110) has at least one power source or voltage source (126) set up to generate an electrical current in the heating cylinder (129) that heats the fluid cylinder (112) by means of Joule heat that arises on passage of the electrical current through the heating cylinder (129).

The invention relates to a device comprising a multitude of hollow cylinder pipes and to a method of heating a feedstock in a fluid cylinder. The device may be part of a plant, for example a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation. The device may especially be used for heating of feedstock to a temperature in the range from 200° C. to 1700° C., preferably from 300° C. to 1400° C., more preferably from 400° C. to 875° C. However, other fields of use are also conceivable.

Such devices are known in principle. For example, WO 2015/197181 A1 describes a device for heating a fluid comprising at least one electrically conductive pipeline for receiving the fluid, and at least one voltage source connected to the at least one pipeline. The at least one voltage source is set up to generate an alternating electrical current in the at least one pipeline, which heats the at least one pipeline in order to heat the fluid.

WO 2020/035575 describes a device for heating a fluid. The device comprises—at least one electrically conductive pipeline and/or at least one electrically conductive pipeline segment for receiving the fluid, and—at least one DC power source and/or DC voltage source, wherein each pipeline and/or each pipeline segment is assigned a DC power source and/or DC voltage source which is connected to the respective pipeline and/or to the respective pipeline segment, wherein the respective DC power source and/or DC voltage source is designed to generate an electrical current in the respective pipeline and/or in the respective pipeline segment which heats the respective pipeline and/or the respective pipeline segment by Joule heat that arises on passage of the electrical current through conductive pipe material, in order to heat the fluid.

WO 2021/160777 A1 describes a device for heating a fluid. The device comprises—at least one electrically conductive pipeline and/or at least one electrically conductive pipeline segment to accommodate the fluid, and—at least one single-phase AC power source and/or at least one single-phase AC voltage source, each pipeline and/or each pipeline segment being assigned a single-phase AC power source and/or a single-phase AC voltage source which is connected to the respective pipeline and/or to the respective pipeline segment, the respective single-phase AC power source and/or single-phase AC voltage source being designed to generate an electrical current in the respective pipeline and/or in the respective pipeline segment, which heats the respective pipeline and/or the respective pipeline segment by Joule heat that arises on passage of the electrical current through conductive pipe material, in order to heat the fluid, the single-phase AC power source and/or the single-phase AC voltage source being connected to the pipeline and/or the pipeline segment in an electrically conducting manner in such a way that the alternating current generated flows into the pipeline and/or the pipeline segment via a forward conductor and flows back to the AC power source and/or AC voltage source via a return conductor.

Further devices for heating fluids are especially also described in other technical fields, for example in U.S. Pat. No. 3,492,463 A, DE 1 690 665 C2, DE 3 118 030 C2, CN 2768367 U, CN202385316U, CN 205546000 U, GB 2 084 284 A, US 2002/028070 A1, US 2013/108251 A. For example, heating of pipelines is described in GB 2 341 442, U.S. Pat. No. 8,763,692 or WO 2011/138596. Further devices are known from FR 2 722 359 A1, CN 106 288 346 B, CN 201 135 883 Y.

However, known devices for heating a fluid in a pipeline are often technically complex or can only be implemented with a high level of technical complexity. Moreover, high demands are made on electrical safety even in the event of a fault.

It is therefore an object of the present invention to provide a device comprising a multitude of hollow cylinder pipes and a method of heating a feedstock, which at least largely avoid the disadvantages of known apparatuses and methods. In particular, the device and the method should be technically simple to implement and perform, and should ensure a high level of electrical safety.

This object is achieved by a device, a method and a plant having the features of the independent claims. Preferred configurations of the invention are specified inter alia in the associated subsidiary claims and dependency references of the subsidiary claims.

The terms “have”, “comprise” or “include” hereinafter or any grammatical variations thereof are used in a non-exclusive manner. Accordingly, these terms may relate either to situations in which there are no further features apart from the feature introduced by these terms or to situations in which there is or are one or more further features. For example, the expression “A has B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when they are used in connection with one or more elements or features and are intended to express that the element or feature may be provided one or more times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, the terms “preferably”, “in particular”, “for example” or similar terms are used hereinafter in connection with optional features, without alternative embodiments being restricted thereby. Thus, features that are introduced by these terms are optional features, and there is no intention to restrict the scope of protection of the claims, and in particular of the independent claims, by these features. Thus, as a person skilled in the art will appreciate, the invention may also be carried out using other configurations. In a similar way, features that are introduced by “in an embodiment of the invention” or by “in a working example of the invention” are understood as optional features, without it being intended that alternative configurations or the scope of protection of the independent claims are restricted thereby. Furthermore, all the possible combinations of the features thereby introduced with other features, whether optional or non-optional features, shall remain unaffected by these introductory expressions.

In a first aspect of the present invention, a device comprising a multitude of hollow cylinder pipes is proposed.

In particular, the device is to be usable and the method described further down is to be employable in a plant selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

At least one of the hollow cylinder pipes is set up as a fluid cylinder to receive at least one feedstock. At least one further hollow cylinder pipe is configured as a current-conducting heating cylinder. The device has at least one power source or voltage source set up to generate an electrical current in the heating cylinder that heats the fluid cylinder by means of Joule heat that arises on passage of the electrical current through the heating cylinder.

There may be a need for a further hollow cylinder that transmits the Joule heat from the heating cylinder to the fluid cylinder. Moreover, a galvanic insulator having insulation properties may be provided, which insulates the fluid cylinder from the electrical voltage (prevention of electric shock), adjoining the current-conducting heating cylinder.

A “hollow cylinder pipe” in the context of the present invention may be understood to mean a pipeline or pipeline segment having an at least partly cylindrical section. A “pipeline” in the context of the present invention may be understood to mean an apparatus of any shape that has an interior delimited from an external environment by an outer face. The pipeline may comprise at least one pipe and/or at least one pipeline segment and/or at least one pipeline coil. A pipeline segment may be a subregion of a pipeline. The expressions “pipeline” and “pipeline segment” and “pipeline coil” are used as synonyms hereinafter. The hollow cylinder pipe may, for example, be a circular cylinder with radius r and a length h, also referred to as height. The circular cylinder may have a bore along an axis. Variances from a circular cylinder geometry are also conceivable. For example, the hollow cylinder pipe may be an elliptical cylinder. For example, the hollow cylinder pipe may be a prismatic cylinder.

Each of the hollow cylinders may have a wall thickness. Each of the hollow cylinders may have an outer face that delimits the respective hollow cylinder from a further hollow cylinder, for example a hollow cylinder surrounding the hollow cylinder or a hollow cylinder surrounded thereby. The hollow cylinder pipes may be configured as pipes that are not cohesive with respect to one another, especially in an embodiment in which the heating cylinder directly surrounds the fluid cylinder. For example, an electrically nonconductive fluid cylinder, for example a ceramic fluid cylinder, may be surrounded by an electrically conductive heating cylinder, for example a metallic heating cylinder, where the pipe of the fluid cylinder and the pipe of the heating cylinder are not cohesively bonded.

The device may have at least two hollow cylinder pipes, especially at least one fluid cylinder and the at least one heating cylinder. It is also possible for further hollow cylinders to be provided, as described further down. The hollow cylinder pipes may at least partly surround one another. “At least partly surround one another” may be understood to mean that at least a subregion of a first hollow cylinder surrounds at least a subregion of a second hollow cylinder. For example, the hollow cylinder pipes may be arranged concentrically to give a common axis. The hollow cylinder pipes may be in a symmetrical arrangement about a common center. Viewed in a cross section, the hollow cylinder pipes may be in a concentric circular arrangement. For example, one of the hollow cylinder pipes may be arranged as a central pipe around which the further hollow cylinder pipes are in a concentric arrangement. The hollow cylinder pipes in this arrangement, viewed from the inside outward, may have an increasing radius and/or diameter.

A “feedstock” in the context of the present invention may be understood to mean any material in principle. The feedstock may include at least one material from which reaction products can be produced and/or prepared, especially by at least one chemical reaction. The reaction can be effected in the fluid cylinder and/or outside the fluid cylinder. The reaction may be an endothermic reaction. The reaction may be a non-endothermic reaction, for example a preheating or heating operation. The feedstock may especially be a reactant with which a chemical reaction is to be conducted. The feedstock may be liquid or gaseous. The feedstock may be a hydrocarbon to be subjected to thermal cracking and/or a mixture. The feedstock may include at least one element selected from the group consisting of: methane, ethane, propane, butane, naphtha, ethylbenzene, gas oil, condensates, biofluids, biogases, pyrolysis oils, waste oils and liquids composed of renewable raw materials. Biofluids may, for example, be fats or oils or derivatives thereof from renewable raw materials, for example bio oil or biodiesel. Other feedstocks are also conceivable. In the context of the present invention, reference is made by way of example to fluids, in a representative manner for any of the other feedstocks listed.

In the context of the present invention, a “fluid cylinder” is understood to mean a hollow cylinder set up to accommodate and/or to transport the feedstock. The geometry and/or surfaces and/or material of the fluid cylinder may be dependent on a feedstock to be transported. The fluid cylinder may, for example, be a pipeline and/or a pipe segment and/or a pipe system. The fluid cylinder may be set up, for example, to perform at least one reaction and/or heat the feedstock. The device, especially the fluid cylinder, may therefore also be referred to as reactor or furnace, especially electrical furnace. For example, the fluid cylinder may be and/or include at least one reaction tube in which at least one chemical reaction can proceed. The geometry and/or surfaces and/or material of the fluid cylinder may also be chosen depending on a desired reaction and/or avoidance of a particular reaction. For example, it is possible to choose ceramic tubes in order to reduce coking. The fluid cylinder may be configured as an electrically conductive hollow cylinder or as an electrically nonconductive hollow cylinder. The fluid cylinder may be a metallic hollow cylinder, for example made of centrifugally cast material, CrNi alloy, or other materials. Alternatively, the fluid cylinder may be nonconductive, for example made from a ceramic or materials of similar specific resistivity. The fluid cylinder may be configured as a hollow cylinder pipe which is not directly heated electrically by Joule heat. The device may be set up to generate an electrical current in the heating cylinder, which heats the fluid cylinder without flow of electrical current through the fluid cylinder.

The device may have a multitude of fluid cylinders. The device may have l fluid cylinders, where l is a natural number not less than two. For example, the device may have at least two, three, four, five or else more fluid cylinders. The device may have, for example, up to one hundred fluid cylinders. The fluid cylinders may be configured identically or differently. The fluid cylinders may be configured differently with regard to diameter and/or length and/or geometry.

The fluid cylinders may comprise symmetric and/or asymmetric pipes and/or combinations thereof. The geometry and/or surfaces and/or material of the fluid cylinder may be dependent on a feedstock to be transported or else dependent on an optimization of the reaction or other factors. In a purely symmetrical configuration, the device may comprise fluid cylinders of an identical pipe type. “Asymmetric pipes” and “combinations of symmetric and asymmetric pipes” may be understood to mean that the device may comprise any combination of pipe types, which may, for example, additionally be connected as desired in parallel or in series. A “pipe type” may be understood to mean one category or type of pipeline characterized by particular features. The pipe type may be characterized at least by one feature selected from the group consisting of: a horizontal configuration of the pipeline; a vertical configuration of the pipeline; a length in the inlet (l1) and/or outlet (l2) and/or transition (l3); a diameter in the inlet (d1) and outlet (d2) and/or transition (d3); number n of passes; length per pass; diameter per pass; geometry; surface; and material.

The device may comprise a combination of at least two different pipe types which are connected in parallel and/or in series. For example, the device may comprise pipelines of different lengths in the inlet (l1) and/or outlet (l2) and/or transition (l3). For example, the device may comprise pipelines with an asymmetry of the diameters in the inlet (d1) and/or outlet (d2) and/or transition (d3). For example, the device may comprise pipelines with a different number of passes. For example, the device may comprise pipelines with passes with different lengths per pass and/or different diameters per pass. In principle, any combination of any pipe type in parallel and/or in series is conceivable.

The device may comprise a multitude of inlets and/or outlets and/or production streams. The fluid cylinders of different or identical pipe types may be arranged in parallel and/or in series with a multitude of inlets and/or outlets. Possible pipelines for fluid cylinders may take the form of various pipe types in the form of a construction kit and may be selected and combined as desired, dependent on an end use. Use of pipelines of different pipe types can enable more accurate temperature control and/or adjustment of the reaction when the feed is fluctuating and/or a selective yield of the reaction and/or an optimized methodology. The pipelines may comprise identical or different geometries and/or surfaces and/or materials.

The pipelines of the fluid cylinders may be through-connected, and hence form a pipe system for receiving the feedstock. A “pipe system” may be understood as meaning an apparatus comprising at least two pipelines, in particular connected to one another. The pipe system may comprise incoming and outgoing pipelines. The pipe system may comprise at least one inlet for receiving the feedstock. The pipe system may comprise at least one outlet for discharging the feedstock. “Through-connected” may be understood as meaning that the pipelines are in fluid connection with one another. Thus, the pipelines may be arranged and connected in such a way that the feedstock flows through the pipelines one after another. Two or more or all of the pipelines may be configured in series and/or in parallel. The pipelines may be interconnected parallel to one another in such a way that the feedstock can flow through at least two pipelines in parallel. The pipelines, in particular the pipelines connected in parallel, may be designed in such a way as to transport different feedstocks in parallel. In particular, the pipelines connected in parallel may have mutually different geometries and/or surfaces and/or materials for transport of different feedstocks. For the transport of a feedstock in particular, a number or all of the pipelines may be in parallel configuration, such that the feedstock can be divided among those pipelines in parallel configuration. There are also conceivable combinations of a series connection and a parallel connection.

The fluid cylinder may be a metallic hollow cylinder or an electrically nonconductive hollow cylinder.

The fluid cylinder may be electrically conductive. “Electrically conductive” may be understood to mean that the fluid cylinder, in particular the material of the fluid cylinder, is designed to conduct electrical current. The fluid cylinder may have a specific electrical resistivity of less than 10⁻¹Ω m. Specific electrical resistivity in the context of the present invention relates to specific electrical resistivity at room temperature. The fluid cylinder may have a specific electrical resistivity ρ of 1·10⁻⁸Ω m≤ρ≤10⁻¹Ω m. For example, the fluid cylinder may have been produced from and/or include one or more metals and alloys such as copper, aluminum, iron, steel or Cr or Ni alloys, graphite, carbon, carbides, silicides. The fluid cylinder may include at least one material selected from the group consisting of ferritic and austenitic materials. For example, the fluid cylinder may have been produced from and/or include a CrNi alloy. For example, the fluid cylinder may have been produced from at least one metal and have a specific electrical resistivity of 1·10⁻⁸Ω to 100·10⁻⁸Ω m. For example, the fluid cylinder may have been produced from metal silicide and have a specific electrical resistivity of 1·10⁻⁸Ω-200·10⁻⁸Ω m. For example, the fluid cylinder may have been produced from metal carbide and have a specific electrical resistivity of 20·10⁻⁸Ω-5000·10⁻⁸Ω m. For example, the fluid cylinder may have been produced from carbon and have a specific electrical resistivity of 50 000·10⁻⁸Ω-100 000·10⁻⁸ m. For example, the fluid cylinder may have been produced from graphite and have a specific electrical resistivity of 5000·10⁻⁸Ω-100 000·10⁻⁸Ω m. For example, the fluid cylinder may have been produced from boron carbide and have a specific electrical resistivity of 10⁻¹-10⁻².

The fluid cylinders and correspondingly incoming and outgoing pipelines may be fluidically connected to one another. In the case of use of electrically conductive pipelines as fluid cylinders, the incoming and outgoing pipelines may be galvanically isolated from one another. “Galvanically isolated from one another” may be understood to mean that the pipelines and the incoming and outgoing pipelines are isolated from one another in such a way that there is no electrical conduction and/or tolerable electrical conduction between the pipelines and the incoming and outgoing pipelines. The device may comprise at least one insulator, in particular a multitude of insulators. Galvanic isolation between the respective pipelines and the incoming and outgoing pipelines can be ensured by the insulators. The insulators can ensure free flow of the feedstock.

However, configurations as electrically nonconductive hollow cylinders or poorly conductive hollow cylinders are also conceivable. The fluid cylinder may be configured as a galvanic insulator. The fluid cylinder may have a specific electrical resistivity of more than 10⁶Ω m. The fluid cylinder may have a specific electrical resistivity ρ of 1×10⁵Ω m≤ρ≤1×10²¹Ω m, preferably of 1×10⁵Ω m≤ρ≤1×10¹⁴Ω m. For example, the fluid cylinder may be configured as a ceramic pipeline. For example, it is possible to use the following materials having the following specific electrical resistivities:

| | Specific electrical |
|---|---|
| Material | resistivity [Ωm] |
| MgO | 10¹² |
| Al2O3 | 10¹³ |
| boron nitride | 10¹³ |
| aluminum nitride | 10¹² |
| aluminum silicate (mullite) | 10¹² |
| ZrO2 | 10¹⁰ |
| magnesium aluminum silicate (cordierite) | 10¹¹ |
| magnesium silicate (steatite) | 10¹² |
| silicon nitride | 10¹² |

A “heating cylinder” in the context of the present invention may be any hollow cylinder set up to transfer energy supplied thereto in the form of heat to the fluid cylinder. The geometry and/or material of the heating cylinder may be matched to the fluid cylinder to be heated. For instance, energy-efficient heating of the fluid cylinder may be possible. A “current-conducting heating cylinder” in the context of the present invention may be understood to mean that the heating cylinder, especially at least one material of the heating cylinder, is set up to conduct an electrical current. The heating cylinder, especially with a connected power source or voltage source, may have a specific electrical resistivity ρ of 1×10⁻⁸Ω m ρ≤10′) m. Semiconductors have a very large bandwidth for specific electrical resistivity, since it is highly dependent on temperature and doping. The heating cylinder may have a thermal conductivity λ of 10 W/(mK)≤λ≤6000 W/(mK), preferably of 20 W/(mK)≤λ≤5000 W/(mK). For example, it is possible to use the following materials having the following specific electrical resistivities and thermal conductivity (thermal conductivity in the context of the present invention relates to thermal conductivity at room temperature):

| | Specific electrical resistivity | |
|---|---|---|
| Material | [Ωm] | λ [W/(mK)] |
| Silicon | 2.3*10³ | 163 |
| Germanium | 4.6*10⁻¹ | 60 |
| GaAs | 10⁻³-10⁻⁸ | 54 |

The heating cylinder may be thermally stable within a range of up to 2000° C., preferably up to 1300° C., more preferably up to 1000° C. “Thermal stability” in the context of the present invention may be understood to mean durability of the heating cylinder, especially of a material of the heating cylinder, with respect to high temperatures in particular.

The heating cylinder may include at least one material selected from the group consisting of ferritic and austenitic materials, for example CrNi alloy, CrMo or ceramic. For example, the heating cylinder may have been produced from at least one metal and/or at least one alloy, such as copper, aluminum, iron, steel or Cr or Ni alloys, graphite, carbon, carbides, silicides. Semiconductors are also conceivable as material for heating cylinders, for example Ge, Si, selenides, tellurides, arsenides, antimonide.

The heating cylinder may have a wall thickness. For example, the wall thickness b_{HZ} of the heating cylinder may be 0.05 mm≥b_{HZ}≥3 mm, for example 0.1 mm≥b_{HZ}≥2 mm. The wall thickness of the heating cylinder may be thinner than a wall thickness of the fluid cylinder.

For example, the wall thickness b_{FZ} of the fluid cylinder may be 5 mm≥b_{FZ}≥8 mm. This may be possible since no fluid flows through and hence higher temperatures can be enabled with the same current flow.

The device has the at least one power source or the at least one voltage source set up to generate an electrical current in the heating cylinder that heats the fluid cylinder by means of Joule heat that arises on passage of the electrical current through the heating cylinder.

The power source and/or the voltage source may comprise a single-phase or multiphase AC power source and/or single-phase or multiphase AC voltage source, or a DC power source and/or DC voltage source. The device may have at least one input and output that electrically connects the power source and/or voltage source to the heating cylinder.

The device may have, for example, at least one AC power source and/or at least one AC voltage source. The AC power source and/or an AC voltage source may be a single-phase or multiphase source. An “AC power source” may be understood to mean a power source designed to provide an alternating current. An “alternating current” may be understood to mean an electrical current of a polarity which changes in a regular repetition over time. For example, the alternating current may be a sinusoidal alternating current. A “single-phase” AC power source may be understood to mean an AC power source which provides an electrical current with a single phase. A “multiphase” AC power source may be understood as meaning an AC power source which provides an electrical current with more than one phase. An “AC voltage source” may be understood to mean a voltage source set up to provide an AC voltage. An “AC voltage” may be understood as meaning a voltage of which the level and polarity are regularly repeated over time. For example, the AC voltage may be a sinusoidal AC voltage. The voltage generated by the AC voltage source causes a current to flow, in particular an alternating current to flow. A “single-phase” AC voltage source may be understood to mean an AC voltage source which provides the alternating current with a single phase. A “multiphase” AC voltage source may be understood to mean an AC voltage source which provides the alternating current with more than one phase.

The device may have at least one DC power source and/or at least one DC voltage source. A “DC power source” may be understood to mean an apparatus set up to provide a DC current. A “DC voltage source” may be understood to mean an apparatus set up to provide a DC voltage. The DC power source and/or DC voltage source may be set up to generate a DC current in the heating cylinder. “DC current” may be understood to mean an electrical current that is substantially constant in terms of strength and direction. “DC voltage” may be understood to mean a substantially constant electrical voltage. “Substantially constant” may be understood to mean a current or a voltage having variations that are immaterial in respect of the intended effect.

The device may have a multitude of power sources and/or voltage sources, said power sources and/or voltage sources being selected from the group consisting of: single-phase or multiphase AC power sources and/or single-phase or multiphase AC voltage sources or DC power sources and/or DC voltage sources, and a combination thereof. The device may have 2 to M different power sources and/or voltage sources, where M is a natural number not less than three. The power sources and/or voltage sources may be configured with or without the possibility of controlling at least one electrical output variable. The power sources and/or voltage sources may be electrically controllable independently of one another. The power sources and/or voltage sources may be of identical or different configuration. For example, the device may be set up such that current and/or voltage are adjustable for different zones, especially heating zones of the device, especially the heating cylinder(s). The device may have a multitude of fluid cylinders. Fluid cylinders may share a common heating cylinder or each have an assigned heating cylinder. The fluid cylinders may belong to different temperature regions or zones. The fluid cylinders themselves may likewise have temperature zones. The individual fluid cylinders may be assigned one or more power sources or voltage sources. The power supply and/or voltage supply may, for example, be adjusted by use of at least one controller, in each case depending on the reaction and methodology. Using a multitude of power sources and/or voltage sources allows the voltage in particular to be varied for different zones. For instance, it is possible to achieve not too high a current, which would result in excessively hot fluid cylinders or, conversely, excessively cold fluid cylinders.

The device may have a multitude of single-phase or multiphase AC power sources or AC voltage sources. The fluid cylinders may each be assigned at least one heating cylinder with at least one AC power source and/or AC voltage source connected to the heating cylinder, especially electrically via at least one electrical connection. Also conceivable are embodiments in which at least two fluid cylinders share a heating cylinder and an AC power source and/or AC voltage source. For connection of the AC power source or AC voltage source and the heating cylinders, the electrically heatable reactor may have 2 to N inputs and outputs, where N is a natural number not less than three. The respective AC power source and/or AC voltage source may be set up to generate an electrical current in the respective heating cylinder. The AC power sources and/or AC voltage sources may either be controlled or uncontrolled. The AC power sources and/or AC voltage sources may be configured with or without the possibility of controlling at least one electrical output variable. An “output variable” may be understood to mean a current value and/or a voltage value and/or a current signal and/or a voltage signal. The device may have 2 to M different AC power sources and/or AC voltage sources, where M is a natural number not less than three. The AC power sources and/or AC voltage sources may be independently electrically controllable. For example, a different current may be generated in the respective heating cylinder and different temperatures reached in the fluid cylinders.

The device may comprise a multitude of DC power sources and/or DC voltage sources. Each fluid cylinder may be assigned at least one heating cylinder and at least one DC power source and/or DC voltage source connected to the heating cylinder, especially electrically via at least one electrical connection. Also conceivable are embodiments in which at least two fluid cylinders share a heating cylinder and a DC power source and/or DC voltage source. For connection of the DC current sources and/or DC voltage sources and the heating cylinder, the device may have 2 to N positive terminals and/or conductors and 2 to N negative terminals and/or conductors, where N is a natural number not less than three. The respective DC power source and/or DC voltage source may be set up to generate an electrical current in the respective heating cylinder. The current generated can heat the respective fluid cylinder by Joule heat that arises on passage of the electrical current through the heating cylinder, in order to heat the feedstock.

The current generated in the heating cylinder can heat the respective fluid cylinder by Joule heat that arises on passage of the electrical current through the heating cylinder, in order to heat the feedstock. “Heating the fluid cylinder” may be understood to mean an operation that leads to a change in a temperature of the fluid cylinder, especially a rise in the temperature of the fluid cylinder. The temperature of the fluid cylinder may remain constant, for example when the reaction that takes place in the fluid cylinder absorbs as much heat as it receives.

The device may be set up to heat the feedstock to a temperature in the range from 200° C. to 1700° C., preferably 300° C. to 1400° C., more preferably 400° C. to 875° C.

The fluid cylinder may be set up to at least partly absorb the Joule heat generated by the heating cylinder and to at least partly release it to the feedstock. At least one endothermic reaction may take place in the fluid cylinder. An “endothermic reaction” may be understood to mean a reaction in which energy, especially in the form of heat, is absorbed from the environment. The endothermic reaction may comprise heating and/or preheating of the feedstock. In particular, the feedstock may be heated in the fluid cylinder. “Heating” the feedstock may be understood to mean an operation that leads to a change in a temperature of the feedstock, especially to a rise in the temperature of the feedstock, for example to heating of the feedstock. The feedstock may, for example, be warmed to a defined or predetermined temperature value by the heating.

The device may be part of a plant. For example, the plant may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

The device may, for example, be part of a steamcracker. “Steam cracking” may be understood as meaning a process in which longer-chain hydrocarbons, for example naphtha, propane, butane and ethane, as well as gas oil and hydrowax, are converted into short-chain hydrocarbons by thermal cracking in the presence of steam. Steamcracking can produce hydrogen, methane, ethene and propene as the main product, and also butenes and pyrolysis benzene inter alia. The steamcracker may be set up to heat the fluid to a temperature in the range from 550° C. to 1100° C.

For example, the device may be part of a reformer furnace. “Steam reforming” may be understood as meaning a process for producing hydrogen and carbon oxides from water and carbon-containing energy carriers, in particular hydrocarbons such as natural gas, light gasoline, methanol, biogas and biomass. For example, the fluid may be heated to a temperature in the range from 200° C. to 875° C., preferably from 400° C. to 700° C.

For example, the device may be part of an apparatus for alkane dehydrogenation. “Alkane dehydrogenation” may be understood as meaning a process for producing alkenes by dehydrogenating alkanes, for example dehydrogenating butane into butenes (BDH) or dehydrogenating propane into propene (PDH). The apparatus for alkane dehydrogenation may be set up to heat the fluid to a temperature in the range from 400° C. to 700° C.

However, other temperatures and temperature ranges are also conceivable.

The device may have a multitude of heating zones. For example, the device may have two or more heating zones. Each heating zone may comprise at least one heating cylinder. The device may also have regions in which there is no heating of the feedstock, for example mere transport zones.

The device may have at least one temperature sensor set up to measure a temperature of the fluid cylinder. The temperature sensor may comprise an electrical or electronic element set up to generate an electrical signal as a function of temperature. For example, the temperature sensor may have at least one element selected from the group consisting of: a high-temperature conductor, a low-temperature conductor, a semiconductor temperature sensor, a temperature sensor with an oscillating crystal, a thermocouple, a pyroelectric material, a pyrometer, a thermal imaging camera, a ferromagnetic temperature sensor, a fiber-optical temperature sensor. The temperature may be measured at the input and output of the feedstock in and/or at the fluid cylinder. For example, it is possible to make measurements at several points in the fluid cylinder in order to determine the temperature over the length of the reactor and to match it to an optimal process regime. Closed-loop control in respect of temperature can be effected by means of at least one closed-loop control element. This can switch off the supply of power or voltage, for example, in the event of a hotspot. When the temperature is too low, the closed-loop control can increase the supply of power or voltage. The temperature sensor may be connected to the closed-loop controller by a remote connection or a fixed connection. The closed-loop controller may be connected to the power source or voltage source by a remote connection or a fixed connection.

The device may have at least one controller unit set up to control the power source or voltage source by closed-loop control as a function of a temperature measured by the temperature sensor. A “controller unit” may generally be understood to mean an electronic device set up to control at least one element of the device by open-loop and/or closed-loop control. For example, the controller unit may be set up to evaluate signals generated by the temperature sensor and to control the power source or voltage source by closed-loop control as a function of the temperature measured. For example, for this purpose, one or more electronic connections may be provided between the temperature sensor and the control unit. The control unit may comprise, for example, at least one data processing device, for example at least one computer or microcontroller. The data processing device may have one or more volatile and/or nonvolatile memory elements, in which case the data processing device may, for example, be programmed to actuate the temperature sensor. The control unit may also comprise at least one interface, for example an electronic interface and/or a human-machine interface, for example an input/output device such as a display and/or a keyboard. The control unit may be built, for example, in a centralized or else decentralized manner. Other configurations are also conceivable. The control unit may include at least one A/D converter. The device may comprise an online temperature measurement. An “online temperature measurement” in the context of the present invention may be understood to mean a measurement of the temperature by the at least one temperature sensor which is made during the transport and/or the reaction of the feedstock in the fluid cylinder. For instance, closed-loop control of the temperature during operation is possible. In particular, a temperature measurement and closed-loop control can be effected over a length of the reactor.

The device may have a multitude of hollow cylinders. The fluid cylinder may be surrounded by further hollow cylinders. The hollow cylinders may be in a concentric arrangement. The fluid cylinder may be arranged as a central hollow cylinder surrounded by the further hollow cylinders. The device may have a multipart configuration, for example with an M-, U- or W-shaped coil as fluid cylinder and mounting of the further hollow cylinders on straight sections of the same length.

The heating cylinder may be arranged such that the heating cylinder surrounds the fluid cylinder. “At least partly surround” may be understood to mean embodiments in which the heating cylinder surrounds the fluid cylinder and embodiments in which only subregions of the fluid cylinder are surrounded by the heating cylinder. For example, the fluid cylinder may be arranged as inner cylinder in the hollow cylinder of the heating cylinder. For example, a multitude of fluid cylinders may be arranged within the heating cylinder. For example, two or more heating cylinders may be arranged in the form of a ring around the fluid cylinders. For example, the fluid cylinder may be spiral-shaped and the heating cylinder may be arranged around the fluid cylinder. There are also conceivable embodiments in which different or identical heating cylinders are arranged around different regions of a fluid cylinder or two or more fluid cylinders, and individual heating of the regions of the fluid cylinders can be enabled.

The heating cylinder may be arranged such that the heating cylinder either directly surrounds the fluid cylinder, especially an electrically nonconductive hollow cylinder, or does so indirectly via an electrically nonconductive hollow cylinder, especially in the case of a fluid cylinder configured as a metallic hollow cylinder. The heating cylinder may be arranged such that the heating cylinder directly surrounds the fluid cylinder, especially a nonmetallic fluid cylinder, and is set up to release its current-generated heat to the fluid cylinder. “Directly” surrounding in the context of the present invention may be understood to mean that the fluid cylinder and the heating cylinder are arranged in the device as adjacent hollow cylinders. In particular, there may be no further hollow cylinder disposed between the fluid cylinder and the heating cylinder. For example, the heating cylinder may be configured as an internally coated metal pipe, for example with a ceramic inner layer and/or a ceramic inner pipe surrounded by a metal pipe.

However, other arrangements of fluid cylinder and the heating cylinder in the device are also conceivable. For example, the heating cylinder may also indirectly surround the fluid cylinder. “Indirectly” surrounding in the context of the present invention may be understood to mean that at least one further element of the device, especially a further hollow cylinder, is disposed between the fluid cylinder and the heating cylinder. The fluid cylinder may be a metallic hollow cylinder. The device may comprise at least one galvanic insulator, especially one that is thermally conductive. The galvanic insulator may be disposed between the fluid cylinder and the heating cylinder. The galvanic insulator may be set up to galvanically insulate the fluid cylinder from the heating cylinder and to transfer heat from the heating cylinder to the fluid cylinder. A “galvanic insulator” in the context of the present invention may especially be understood to mean a nonconductor or poor conductor. The galvanic insulator may have a specific electrical resistivity ρ of 1×10⁵ Ω≤ρ≤1×10¹⁴Ω m. For example, it is possible to use the following materials having the following specific electrical resistivities:

| | Specific electrical |
|---|---|
| Material | resistivity [Ωm] |
| MgO | 10¹² |
| Al2O3 | 10¹³ |
| boron nitride | 10¹³ |
| aluminum nitride | 10¹² |
| aluminum silicate (mullite) | 10¹² |
| ZrO2 | 10¹⁰ |
| magnesium aluminum silicate (cordierite) | 10¹¹ |
| magnesium silicate (steatite) | 10¹² |
| silicon nitride | 10¹² |

A coefficient of heat transfer may be high. The galvanic insulator may have a thermal conductivity λ of 10 W/(mK)≤λ≤6000 W/(mK), preferably of 20 W/(mK)≤λ≤5000 W/(mK).

The galvanic insulator may include at least one material selected from the group consisting of ceramic, glassy, glass fiber-reinforced, plastic-like or resin-like materials, for example ceramic, steatite, porcelain, glass, glass fiber-reinforced plastic, epoxy resin, thermoset, elastomers, and also sufficiently electrically insulating liquids, an insulating paint. The galvanic insulator may be configured as one or more of the following: a tube, a thin film, a covering, or a layer.

The galvanic insulator may be set up to transfer heat from the electrified heating cylinder to the fluid cylinder. At the same time, the galvanic insulator can galvanically insulate the fluid cylinder from the heating cylinder.

The device may include at least one outer cylinder. An “outer cylinder” may be understood to mean a hollow cylinder disposed further to the outside than the heating cylinder, especially in a concentric arrangement. The outer cylinder may be the outermost hollow cylinder and accommodate all the hollow cylinders of the device. The outer cylinder may be set up as a housing. The outer cylinder may be set up to at least partly surround the heating cylinder. The outer cylinder may be set up to insulate the heating cylinder both galvanically and thermally and to at least partly reduce heat loss to the outside. “At least partly reduce heat loss to the outside” in the context of the present invention may be understood to mean embodiments with complete thermal insulation, and also embodiments in which there is incomplete heat reduction of the heat from the heating cylinder, for example down to a predetermined temperature. For example, the outer cylinder may surround at least a subregion along the heating cylinder, for example in at least a particularly heat-sensitive outer region of the environment. The outer cylinder, with regard to the materials used, may be set up with a specific electrical resistivity and thermal conductivity like the galvanic insulator described.

The device has a multitude of advantages over known apparatuses.

The device may make it possible for device regions, especially the fluid cylinder and the outer cylinder, not to be electrified even in the event of a fault, such that it is possible to avoid electric shocks to people who come into contact with device parts. Much higher current and voltage levels may be possible. All kinds of current and/or voltage may be utilizable.

Temperature measurement and closed-loop control may be possible by means of installed temperature sensors and closed-loop current and/or voltage control. The device may have a multipart configuration, for example with an M-, U- or W-shaped coil as fluid cylinder and mounting of the further hollow cylinders on straight sections of the same length. Conventional coil concepts may be largely retained.

The device may be used as an electrical furnace. Utilization as a hybrid furnace may also be possible, operated, for example, with gas, power, or gas and power. It may also be possible for two or more furnaces to be heated independently by power or gas. It is possible to use thermal integration concepts as described, for example, in European patent application 20 199 922.4, filed Oct. 2, 2020, the contents of which are hereby incorporated by reference. For example, the device may be used in a plant for production of reaction products. The plant may have at least one preheater. The plant may have at least one raw material feed set up to feed at least one raw material, i.e. the feedstock, to the preheater. The preheater may be set up to preheat the raw material to a predetermined temperature. The plant may include the at least one device as an electrically heatable reactor. The electrically heatable reactor may be set up to at least partly convert the preheated raw material to reaction products and by-products. The plant may have at least one thermal integration apparatus set up to at least partly supply the by-products to the preheater. The preheater may be set up to at least partly utilize energy required for preheating of the raw material from the by-products. Waste heat from the reactor (condenser, increasing temperature of the cooling medium) can thus be used to heat the starting materials (e.g. naphtha, steam, air, etc.).

In a further aspect, in the context of the present invention, a plant comprising a device of the invention is proposed. With regard to the configuration of the plant, reference is made to the description of the devices further up or down.

The plant may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

In a further aspect, in the context of the present invention, a method of heating a feedstock is proposed. In the method, a device of the invention is used.

The method comprises the following steps:
providing at least one fluid cylinder for receiving the feedstock and receiving the feedstock in the fluid cylinder;
providing at least one power source and/or at least one voltage source;
generating an electrical current in at least one current-conducting heating cylinder that heats the fluid cylinder by means of Joule heat that arises on passage of the electrical current through the heating cylinder, for heating of the feedstock.

With regard to embodiments and definitions, reference may be made to the above description of the device. The method steps may be carried out in the sequence specified, although it is also possible for one or more of the steps to be conducted simultaneously at least in part, and it is also possible for one or more of the steps to be repeated more than once. In addition, further steps may be additionally performed, irrespective of whether or not they have been mentioned in the present description.

In summary, in the context of the present invention, particular preference is given to the following embodiments:
Embodiment 1 A device comprising a multitude of hollow cylinder pipes, wherein at least one of the hollow cylinder pipes is set up as a fluid cylinder to receive at least one feedstock, wherein at least one further hollow cylinder pipe is configured as a current-conducting heating cylinder, wherein the device has at least one power source or voltage source set up to generate an electrical current in the heating cylinder that heats the fluid cylinder by means of Joule heat that arises on passage of the electrical current through the heating cylinder.
Embodiment 2 The device according to the preceding embodiment, wherein the device is set up to heat the feedstock to a temperature in the range from 200° C. to 1700° C., preferably 300° C. to 1400° C., more preferably 400° C. to 875° C.
Embodiment 3 The device according to either of the preceding embodiments, wherein the device has at least one temperature sensor set up to determine a temperature of the fluid cylinder, where the device has at least one controller unit set up to control the power source or voltage source by closed-loop control as a function of a temperature measured by the temperature sensor.
Embodiment 4 The device according to any of the preceding embodiments, wherein the fluid cylinder is a metallic hollow cylinder or an electrically nonconductive hollow cylinder.
Embodiment 5 The device according to any of the preceding embodiments, wherein the heating cylinder is arranged such that the heating cylinder surrounds the fluid cylinder.
Embodiment 6 The device according to the preceding embodiment, wherein the heating cylinder is arranged such that the heating cylinder directly surrounds the fluid cylinder and is set up to release its current-generated heat to the fluid cylinder.
Embodiment 7 The device according to embodiment 5, wherein the fluid cylinder is a metallic hollow cylinder, wherein the device has at least one galvanic insulator, wherein the galvanic insulator is disposed between the fluid cylinder and the heating cylinder, wherein the galvanic insulator is set up to galvanically insulate the fluid cylinder from the heating cylinder and to transfer heat from the heating cylinder to the fluid cylinder.
Embodiment 8 The device according to the preceding embodiment, wherein the galvanic insulator includes at least one material selected from the group consisting of ceramic, glassy, glass fiber-reinforced, plastic-like or resin-like materials, an insulating paint, where the galvanic insulator is configured as one or more of the following: a tube, a thin film, a covering, or a layer.
Embodiment 9 The device according to any of the preceding embodiments, wherein the device has at least one outer cylinder, where the outer cylinder is set up to at least partly surround the heating cylinder, where the outer cylinder is set up to galvanically insulate the heating cylinder and to at least partly reduce a loss of heat to the outside.
Embodiment 10 The device according to any of the preceding embodiments, wherein the heating cylinder has a specific electrical resistivity ρ of 1×10⁻⁸Ω m≤ρ≤10⁵Ω m.
Embodiment 11 The device according to any of the preceding embodiments, wherein the heating cylinder and the galvanic insulator have a thermal conductivity λ of 10 W/(mK)≤λ≤6000 W/(mK), preferably of 20 W/(mK)≤λ≤5000 W/(mK).
Embodiment 12 The device according to any of the preceding embodiments, wherein the heating cylinder is thermally stable within a range up to 2000° C., preferably up to 1300° C., more preferably up to 1000° C.
Embodiment 13 The device according to any of the preceding embodiments, wherein the heating cylinder includes at least one material selected from the group consisting of ferritic and austenitic materials.
Embodiment 14 The device according to any of the preceding embodiments, wherein the power source and/or voltage source comprises a single-phase or multiphase AC power source and/or a single-phase or multiphase AC voltage source, or a DC power source and/or DC voltage source.
Embodiment 15 The device according to any of the preceding embodiments, wherein the device has a multitude of fluid cylinders, where said device has l fluid cylinders, where l is a natural number not less than two, where said fluid cylinders have symmetric or asymmetric pipes and/or a combination thereof.
Embodiment 16 The device according to the preceding embodiment, wherein the fluid cylinders are of different configuration in terms of diameter, and/or length, and/or geometry.
Embodiment 17 The device according to either of the two preceding embodiments, wherein two or more or all of the fluid cylinders are in series and/or parallel configuration.
Embodiment 18 The device according to any of the preceding embodiments, wherein the feedstock is a hydrocarbon to be subjected to thermal cleavage and/or a mixture.
Embodiment 19 A plant comprising at least one device according to any of the preceding embodiments relating to a device, wherein the plant is selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.
Embodiment 20 A method of heating at least one feedstock using a device according to any of the preceding embodiments, said method comprising the following steps:
   providing at least one fluid cylinder for receiving the feedstock and receiving the feedstock in the fluid cylinder;
   providing at least one power source and/or at least one voltage source;
   generating an electrical current in at least one current-conducting heating cylinder that heats the fluid cylinder by means of Joule heat that arises on passage of the electrical current through the heating cylinder, for heating of the feedstock.

### BRIEF DESCRIPTION OF THE FIGURES

Further details and features of the invention will be apparent from the description of preferred working examples that follows, in particular in conjunction with the subsidiary claims. The respective features may in this case be implemented on their own, or two or more may be implemented in combination with one another. The invention is not restricted to the working examples. The working examples are illustrated diagrammatically in the figures. Identical reference numerals in the individual figures relate to elements that are the same or have the same function, or correspond to one another in terms of their functions.

The individual figures show:

FIGS. 1a to 1d embodiments of the device of the invention having two to 4 cylinders;

FIGS. 2a to 2d embodiments of the device of the invention having a multitude of fluid pipes;

FIGS. 3a to 3b embodiments of the device of the invention comprising two heating zones with a galvanically conductive fluid cylinder having one power/voltage source;

FIGS. 3c to 3d embodiments of the device of the invention comprising two heating zones with a galvanically insulating fluid cylinder having one power/voltage source;

FIGS. 4a to 4b embodiments of the device of the invention comprising two heating zones with a galvanically conductive fluid cylinder having two power/voltage sources;

FIGS. 4c to 4d embodiments of the device of the invention comprising two heating zones with a galvanically insulating fluid cylinder having two power/voltage sources;

FIGS. 5a to 5d embodiments of the device of the invention from FIGS. 1a to 1d using 3-phase AC power;

FIGS. 6a to 6d embodiments of the device of the invention from FIGS. 2a to 2d using 3-phase AC power;

FIGS. 7a to 7d embodiments of the device of the invention from FIGS. 3a to 3d using 3-phase AC power;

FIGS. 8a to 8y embodiments of the device of the invention with a construction kit having pipe types for possible fluid cylinders or pipes and inventive working examples of combinations of fluid cylinders and fluid pipes;

FIGS. 9a1 to 9a2 further embodiments of the device of the invention using a galvanically conductive fluid cylinder, where 9a1 is provided without and 9a2 is provided with temperature sensors and closed-loop controllers;

FIGS. 9b to 9g embodiments of the device of the invention from FIGS. 9a1 to 9a2 using various power/voltage sources;

FIGS. 10a1 to 10a2 embodiments of the device of the invention from FIGS. 9a1 to 9a2 using a galvanically insulating fluid cylinder, where 10a1 is provided without and 10a2 is provided with temperature sensors and closed-loop controllers;

FIGS. 10b to 10g embodiments of the device of the invention from FIGS. 10a1 to 10a2 using various power/voltage sources.

### WORKING EXAMPLES

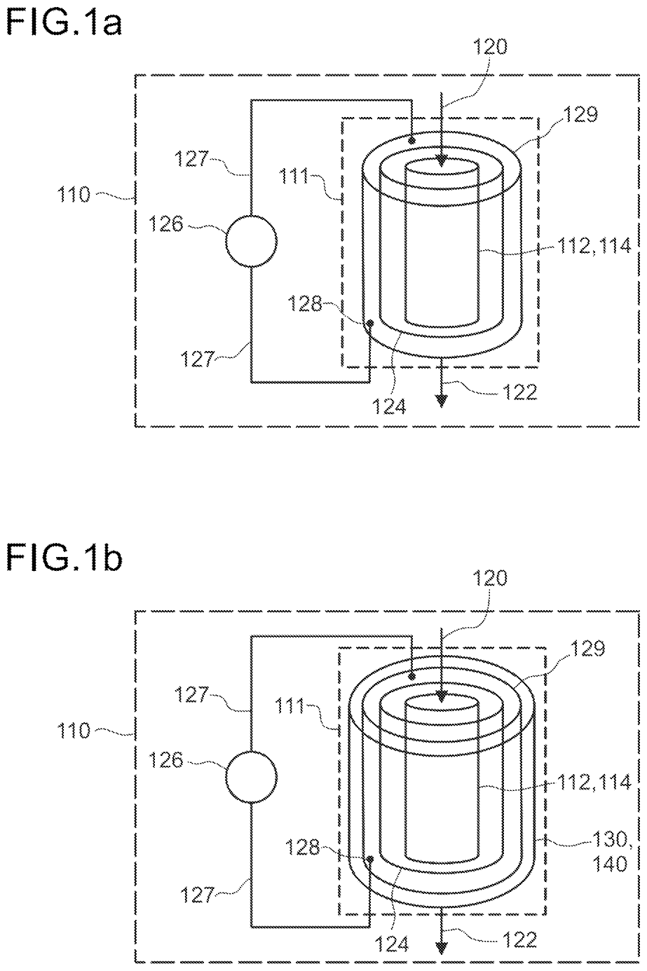

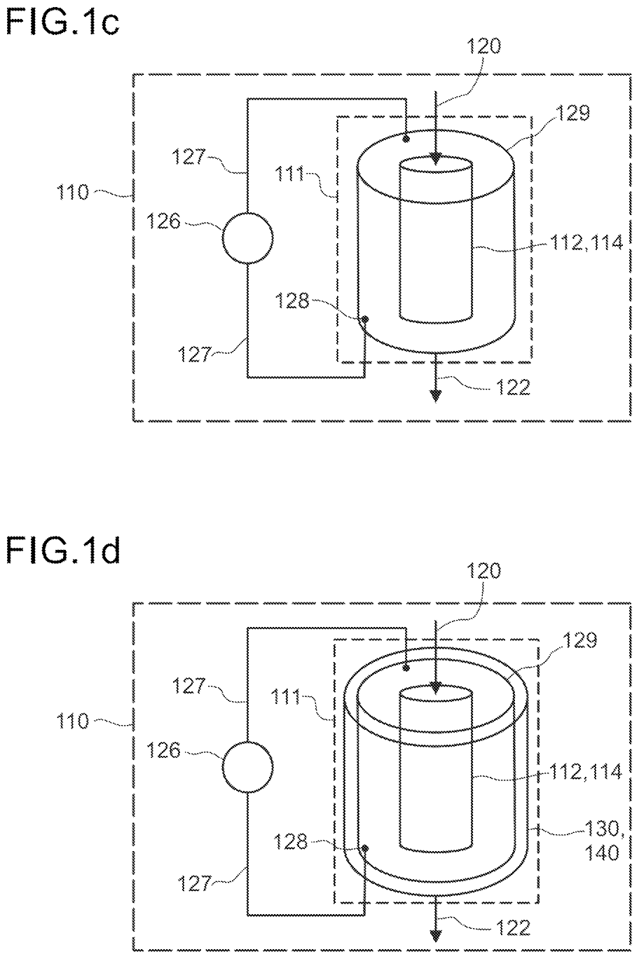

FIGS. 1a to 1d each show a schematic diagram of a working example of an inventive device 110 with three hollow cylinder pipes. The device 110 may have at least one reactive space 111.

The hollow cylinder pipes may each comprise a pipeline or pipeline segment having an at least partly cylindrical section. Each hollow cylinder pipe may, for example, be a circular cylinder with radius r and a length h, also referred to as height. The circular cylinder may have a bore along an axis. Variances from a circular cylinder geometry are also conceivable.

For example, the hollow cylinder pipe may be an elliptical cylinder. For example, the hollow cylinder pipe may be a prismatic cylinder.

At least one of the hollow cylinder pipes is set up as a fluid cylinder 112, or fluid cylinder segment 114, to receive at least one feedstock.

The feed or feedstock may be any material in principle. The feedstock may include at least one material from which reaction products can be produced and/or prepared, especially by at least one chemical reaction. The reaction can be effected in the fluid cylinder 112 and/or outside the fluid cylinder 112. The reaction may be an endothermic reaction. The reaction may be a non-endothermic reaction, for example a preheating or heating operation. The feedstock may especially be a reactant with which a chemical reaction is to be conducted. The feedstock may be liquid or gaseous. The feedstock may be a hydrocarbon to be subjected to thermal cracking and/or a mixture. The feedstock may include at least one element selected from the group consisting of: methane, ethane, propane, butane, naphtha, ethylbenzene, gas oil, condensates, biofluids, biogases, pyrolysis oils, waste oils and liquids composed of renewable raw materials. Biofluids may, for example, be fats or oils or derivatives thereof from renewable raw materials, for example bio oil or biodiesel. Other feedstocks are also conceivable.

The fluid cylinder 112 may be a hollow cylinder set up to receive and/or to transport the feedstock. The fluid cylinder 112 may have at least one inlet 120 for receiving the feedstock. The fluid cylinder 112 may have at least one outlet 122 for discharging the feedstock.

The geometry and/or surfaces and/or material of the fluid cylinder may be pending on a feedstock to be transported. The fluid cylinder 112 may, for example, be a pipeline and/or a pipe segment (reference numeral 114) and/or a pipe system 118. The terms “pipeline”, “pipe segment” and “pipe system” are used as synonyms hereinafter, with reference solely to a pipeline as fluid cylinder 112. The fluid cylinder 112 may be set up, for example, to perform at least one reaction and/or heat the feedstock. For example, the fluid cylinder 112 may be and/or include at least one reaction tube in which at least one chemical reaction can proceed. The geometry and/or surfaces and/or material of the fluid cylinder 112 may also be chosen depending on a desired reaction and/or avoidance of a particular reaction. For example, it is possible to choose ceramic tubes in order to reduce coking. The fluid cylinder 112 may be configured as an electrically conductive hollow cylinder or as an electrically nonconductive hollow cylinder. The fluid cylinder 112 may be a metallic hollow cylinder, for example made of centrifugally cast material, CrNi alloy, or other materials. Alternatively, the fluid cylinder 112 may be nonconductive, for example made from a ceramic or materials of similar specific resistivity.

At least one further hollow cylinder pipe is configured as a current-conducting heating cylinder 129. The device 110 has at least one power source or voltage source 126 set up to generate an electrical current in the heating cylinder 129 that heats the fluid cylinder 112 by means of Joule heat that arises on passage of the electrical current through the heating cylinder 112.

The device 110 may have at least two hollow cylinder pipes, especially at least the at least one fluid cylinder 114 and the at least one heating cylinder 129. It is also possible for further hollow cylinders to be provided, as shown in FIG. 1. The hollow cylinder pipes may at least partly surround one another. For example, the hollow cylinder pipes may be arranged concentrically to give a common axis. The hollow cylinder pipes may be in a symmetrical arrangement about a common center. Viewed in a cross section, the hollow cylinder pipes may be in a concentric circular arrangement. For example, one of the hollow cylinder pipes, for example the fluid cylinder 112, may be arranged as a central pipe around which the further hollow cylinder pipes are in a concentric arrangement. The hollow cylinder pipes in this arrangement, viewed from the inside outward, may have an increasing radius and/or diameter.

The fluid cylinder 112, as shown in FIGS. 1a to 1b, may be a galvanically conductive hollow cylinder and, as shown in FIGS. 1c to 1d, may be a galvanically nonconductive hollow cylinder. The fluid cylinder 112 may be electrically conductive or galvanically nonconductive. The fluid cylinder 112 may have a specific electrical resistivity of less than 10⁻¹Ω m. The fluid cylinder 112 may have a specific electrical resistivity ρ of 1×10⁻⁸Ω m≤ρ≤10⁻¹Ω m. For example, the fluid cylinder 112 may have been produced from and/or include one or more metals and alloys such as copper, aluminum, iron, steel or Cr or Ni alloys, graphite, carbon, carbides, silicides. The fluid cylinder 112 may include at least one material selected from the group consisting of ferritic and austenitic materials. For example, the fluid cylinder 112 may have been produced from and/or include a CrNi alloy. For example, the fluid cylinder 112 may have been produced from at least one metal and have a specific electrical resistivity of 1*10⁻⁸Ω-100*10⁻⁸Ω m. For example, the fluid cylinder 112 may have been produced from metal silicide and have a specific electrical resistivity of 1*10⁻⁸Ω-200*10⁻⁸Ω m. For example, the fluid cylinder 112 may have been produced from metal carbide and have a specific electrical resistivity of 20*10⁻⁸Ω-5000*10⁻⁸Ω m. For example, the fluid cylinder 112 may have been produced from carbon and have a specific electrical resistivity of 50 000*10⁻⁸Ω-100 000*10⁻⁸Ω m. For example, the fluid cylinder 112 may have been produced from graphite and have a specific electrical resistivity of 5000*10⁻⁸Ω-100 000*10⁻⁸Ω m. For example, the fluid cylinder 112 may have been produced from boron carbide and have a specific electrical resistivity of 10⁻¹-10⁻². However, other embodiments as electrically nonconductive hollow cylinder are also conceivable.

The fluid cylinder 112 may be configured as a galvanic insulator. The fluid cylinder 112 may have a specific electrical resistivity of more than 10⁶Ω m. The fluid cylinder 112 may have a specific electrical resistivity ρ of 1×10⁵Ω m≤ρ≤1×10²⁰Ω m, preferably of 1×10⁵ 4 m≤ρ≤1×10¹⁴Ω m. For example, the fluid cylinder 112 may be configured as a ceramic pipeline. For example, it is possible to use the following materials having the following specific electrical resistivities:

| | Specific electrical |
|---|---|
| Material | resistivity [Ωm] |
| MgO | 10¹² |
| Al2O3 | 10¹³ |
| boron nitride | 10¹³ |
| aluminum nitride | 10¹² |
| aluminum silicate (mullite) | 10¹² |
| ZrO2 | 10¹⁰ |
| magnesium aluminum silicate (cordierite) | 10¹¹ |
| magnesium silicate (steatite) | 10¹² |
| silicon nitride | 10¹² |

The heating cylinder 129 may be any hollow cylinder set up to transfer energy supplied thereto in the form of heat to the fluid cylinder 112. The geometry and/or material of the heating cylinder 129 may be matched to the fluid cylinder 112 to be heated. For instance, energy-efficient heating of the fluid cylinder may be possible. The heating cylinder 129, especially with a connected power source or voltage source, may have a specific electrical resistivity ρ of 1×10⁻⁸Ω m≤ρ≤10⁵ m. The heating cylinder 129 may have a thermal conductivity λ of 10 W/(mK)≤λ≤6000 W/(mK), preferably of 20 W/(mK)≤λ≤5000 W/(mK). For example, it is possible to use the following materials having the following specific electrical resistivities and thermal conductivity:

| Material | ρ [Ωm] | [W/(mK)] |
|---|---|---|
| Silicon | 2.3*10³ | 163 |
| Germanium | 4.6*10⁻¹ | 60 |
| GaAs | 10⁻³-10⁻⁸ | 54 |

The heating cylinder 129 may be thermally stable within a range of up to 2000° C., preferably up to 1300° C., more preferably up to 1000° C. The heating cylinder 129 may include at least one material selected from the group consisting of ferritic and austenitic materials, for example CrNi alloy, CrMo or ceramic. For example, the heating cylinder 129 may have been produced from at least one metal and/or at least one alloy, such as copper, aluminum, iron, steel or Cr or Ni alloys, graphite, carbon, carbides, silicides. Semiconductors are also conceivable as material for heating cylinders 129, for example Ge, Si, selenides, tellurides, arsenides, antimonide.

The device 110 has the at least one power source or the at least one voltage source 126 set up to generate an electrical current in the heating cylinder 129 that heats the fluid cylinder 112 by means of Joule heat that arises on passage of the electrical current through the heating cylinder 129.

The power source and/or the voltage source 126 may comprise a single-phase or multiphase AC power source and/or single-phase or multiphase AC voltage source, or a DC power source and/or DC voltage source. The device 110 may have at least one input and output 127 that electrically connects the power source and/or voltage source 126 to the heating cylinder 129, especially via electrical terminals 128.

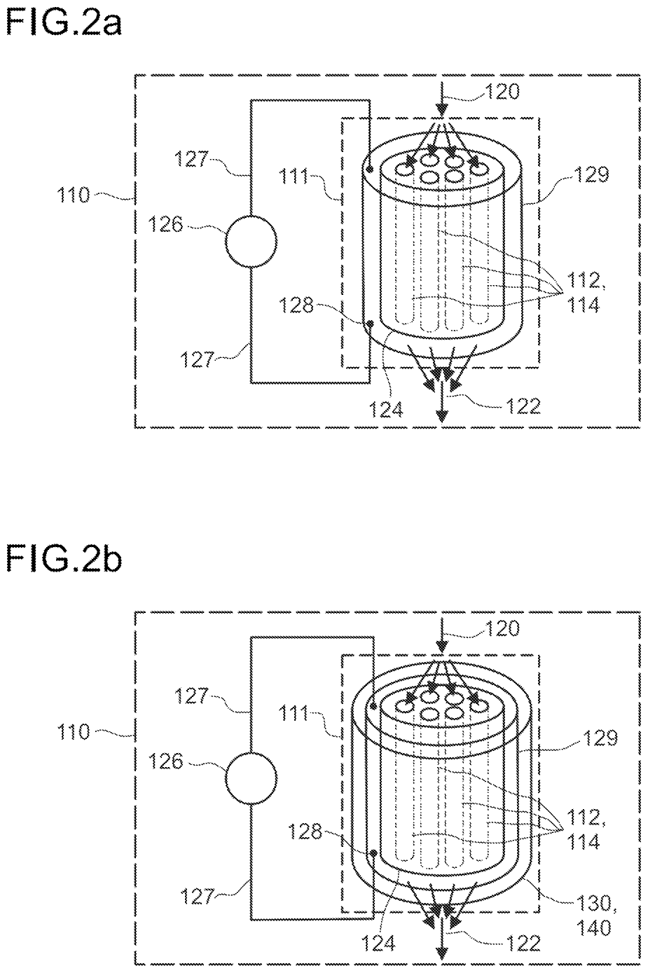

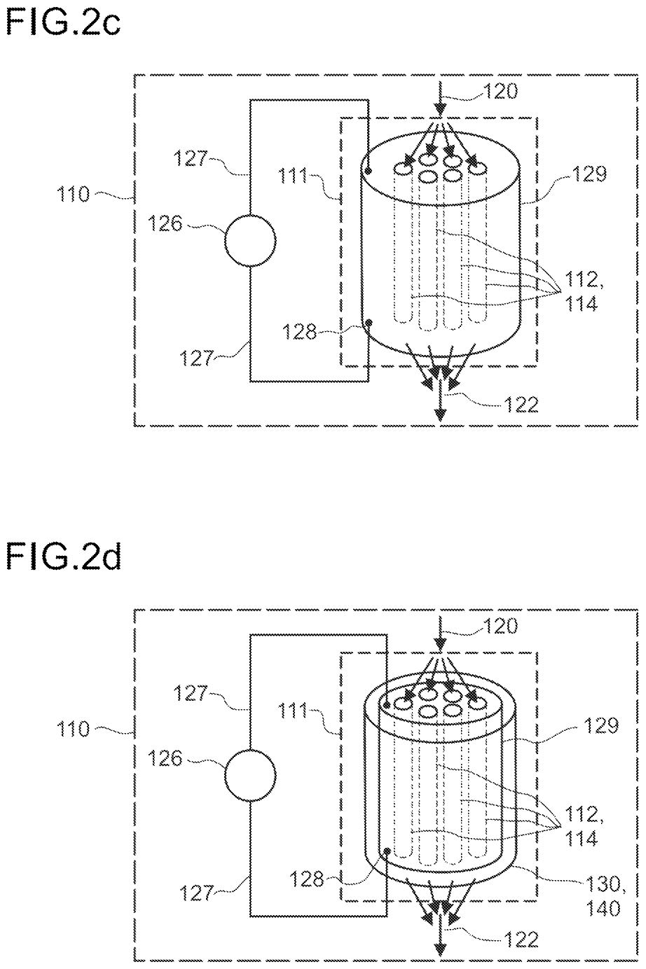

The heating cylinder 129 may be arranged such that the heating cylinder 129 surrounds the fluid cylinder 112. For example, the fluid cylinder 112, as shown in FIGS. 1a to 1d, may be disposed as inner cylinder in the hollow cylinder of the heating cylinder 129. For example, a multitude of fluid cylinders 112 may be disposed within the heating cylinder 129, as shown, for example, in FIGS. 2a to 2d.

The current generated in the heating cylinder 129 can heat the respective fluid cylinder 112 by Joule heat that arises on passage of the electrical current through the heating cylinder 129, in order to heat the feedstock. The heating of the fluid cylinder 112 may comprise an operation that leads to a change in a temperature of the fluid cylinder 112, especially a rise in the temperature of the fluid cylinder 112. The temperature of the fluid cylinder 112 may remain constant, for example when the reaction that takes place in the fluid cylinder 112 absorbs as much heat as it receives. The device 110 may be set up to heat the feedstock to a temperature in the range from 200° C. to 1700° C., preferably 300° C. to 1400° C., more preferably 400° C. to 875° C.

The heating cylinder 129 may be arranged such that the heating cylinder 129 either directly surrounds the fluid cylinder 112, especially an electrically nonconductive hollow cylinder, or does so indirectly via an electrically nonconductive hollow cylinder, especially in the case of a fluid cylinder 112 configured as a metallic hollow cylinder.

FIG. 1a shows an embodiment in which the heating cylinder 129 indirectly surrounds the fluid cylinder 112. The fluid cylinder 112 may be a metallic hollow cylinder. The device 110 in this embodiment has a further hollow cylinder between heating cylinder 129 and fluid cylinder 112. The device 110 may have at least one galvanic insulator 124, especially one that is thermally conductive, which enables indirect heat transfer from heating cylinder 129 to fluid cylinder 112. The galvanic insulator 124 may be disposed between the fluid cylinder 112 and the heating cylinder 129. The galvanic insulator 124 may be set up to galvanically insulate the fluid cylinder 112 from the heating cylinder 129 and to transfer heat from the heating cylinder 129 to the fluid cylinder 112. The galvanic insulator 124 may have points a specific electrical resistivity ρ of 1×10⁵Ω m≤ρ≤1×10¹⁴Ω m. A coefficient of heat transfer may be high. The galvanic insulator 124 may have a thermal conductivity λ of 10 W/(mK)≤λ≤6000 W/(mK), preferably of 20 W/(mK)≤Δ≤5000 W/(mK).

The galvanic insulator 124 may include at least one material selected from the group consisting of ceramic, glassy, glass fiber-reinforced, plastic-like or resin-like materials, for example ceramic, steatite, porcelain, glass, glass fiber-reinforced plastic, epoxy resin, thermoset, elastomers, and also sufficiently electrically insulating liquids, an insulating paint. The galvanic insulator 124 may be configured as one or more of the following: a tube, a thin film, a covering, or a layer. For example, it is possible to use the following materials having the following specific electrical resistivities:

| | Specific electrical |
|---|---|
| Material | resistivity [Ωm] |
| MgO | 10¹² |
| Al2O3 | 10¹³ |
| boron nitride | 10¹³ |
| aluminum nitride | 10¹² |
| aluminum silicate (mullite) | 10¹² |
| ZrO2 | 10¹⁰ |
| magnesium aluminum silicate (cordierite) | 10¹¹ |
| magnesium silicate (steatite) | 10¹² |
| silicon nitride | 10¹² |

The galvanic insulator 124 may be set up to transfer heat from the electrified heating cylinder 129 to the fluid cylinder 112. At the same time, the galvanic insulator 124 can galvanically insulate the fluid cylinder 112 from the heating cylinder 129.

FIG. 1b shows a further embodiment of the invention in which the device 110, in addition to the embodiment shown in FIG. 1a, has an outer cylinder 130. The outer cylinder 130 may be a thermal insulator 140, especially for outer thermal insulation. The outer cylinder 130 may be a hollow cylinder disposed further to the outside than the heating cylinder 120, especially in a concentric arrangement. The outer cylinder 130 may be the outermost hollow cylinder and accommodate all the hollow cylinders of the device 110. The outer cylinder 130 may be set up as a housing. The outer cylinder 130 may be set up to at least partly surround the heating cylinder 129. The outer cylinder 130 may be set up to galvanically insulate the heating cylinder 129 and to at least partly reduce heat loss to the outside. For example, the outer cylinder 130 may surround at least a subregion along the heating cylinder 129, for example in at least a particularly heat-sensitive outer region of the environment. The outer cylinder 130, with regard to the materials used, specific electrical resistivity and thermal conductivity, may be set up with a specific electrical resistivity and thermal conductivity like the galvanic insulator described 124.

FIG. 1c shows a further embodiment of the inventive device 110. By comparison with the embodiment shown in FIG. 1a, FIG. 1c lacks the galvanic insulator 124. The heating cylinder 129 in this embodiment is arranged such that the heating cylinder 129 directly surrounds the fluid cylinder 112, especially a nonmetallic fluid cylinder, and is set up to release its current-generated heat to the fluid cylinder 112. The fluid cylinder 112 and the heating cylinder 129 are arranged as adjacent hollow cylinders in the device 110. In particular, there may be no further hollow cylinder disposed between the fluid cylinder 112 and the heating cylinder 129. FIG. 1d shows a further embodiment of the invention in which the device 110, in addition to the embodiment shown in FIG. 1c, has an outer cylinder 130. With regard to the configuration of the outer cylinder 130, reference may be made to the description of FIG. 1b.

FIGS. 2a to 2d show embodiments of the inventive device 110 having a multitude of fluid pipes 112.

The device 110 may have a multitude of fluid cylinders 112. The device may have l fluid cylinders, where l is a natural number not less than two. For example, the device 110 may have at least two, three, four, five or more fluid cylinders 112. The device 110 may have, for example, up to one hundred fluid cylinders 112. The fluid cylinders 112 may be of identical or different configuration. The fluid cylinders 112 may be configured differently with regard to diameter, and/or length, and/or geometry.

The device 110 may comprise a multitude of inlets 120 and/or outlets 122 and/or production streams. The fluid cylinders 112 of different or identical pipe types may be arranged in parallel and/or in series with a plurality of inlets 120 and/or outlets 122. Possible pipelines for fluid cylinders 112 may take the form of various pipe types in the form of a construction kit and may be selected and combined as desired, dependent on an end use. Use of pipelines of different pipe types can enable more accurate temperature control and/or adjustment of the reaction when the feed is fluctuating and/or a selective yield of the reaction and/or an optimized methodology. The pipelines may comprise identical or different geometries and/or surfaces and/or materials.

FIG. 2a shows one embodiment of the inventive device 110, similarly to FIG. 1a, with provision of a multitude of fluid cylinders 112 by comparison with FIG. 1a. In particular, the fluid cylinders 112 may be surrounded by a common heating cylinder 129. However, other embodiments are also conceivable, in which, for example, each fluid cylinder 112 is assigned an individual heating cylinder 129 or in which only some fluid cylinders share a common heating cylinder 120. FIG. 2b shows an embodiment of the invention similarly to FIG. 2a, wherein the outer cylinder 130 is additionally provided, as described with regard to FIG. 1b. FIG. 2c shows an embodiment of the invention similar to that in FIG. 1c, again with provision of a multitude of fluid cylinders 112 by comparison with FIG. 1c. FIG. 2d shows an embodiment of the invention similar to that in FIG. 1d, again with provision of a multitude of fluid cylinders 112 by comparison with FIG. 1d.

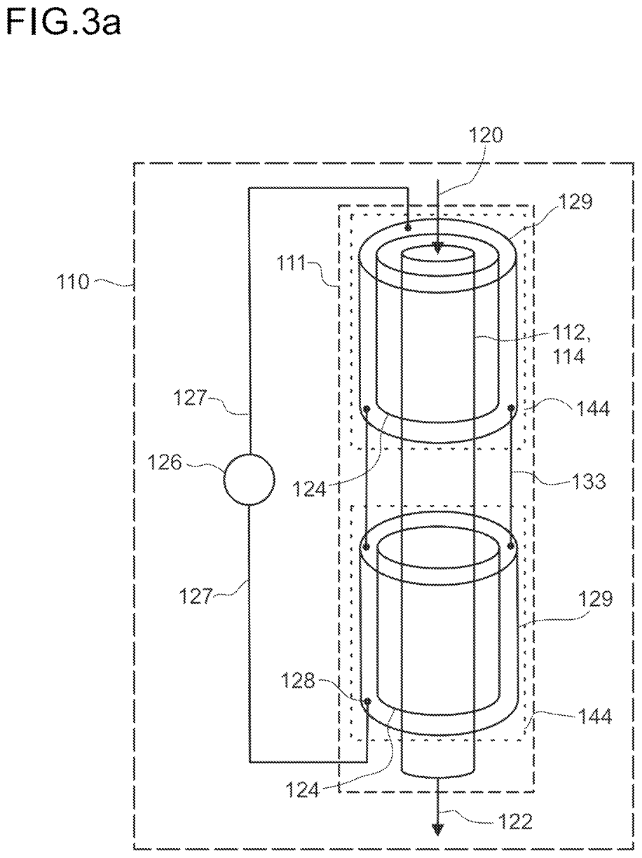

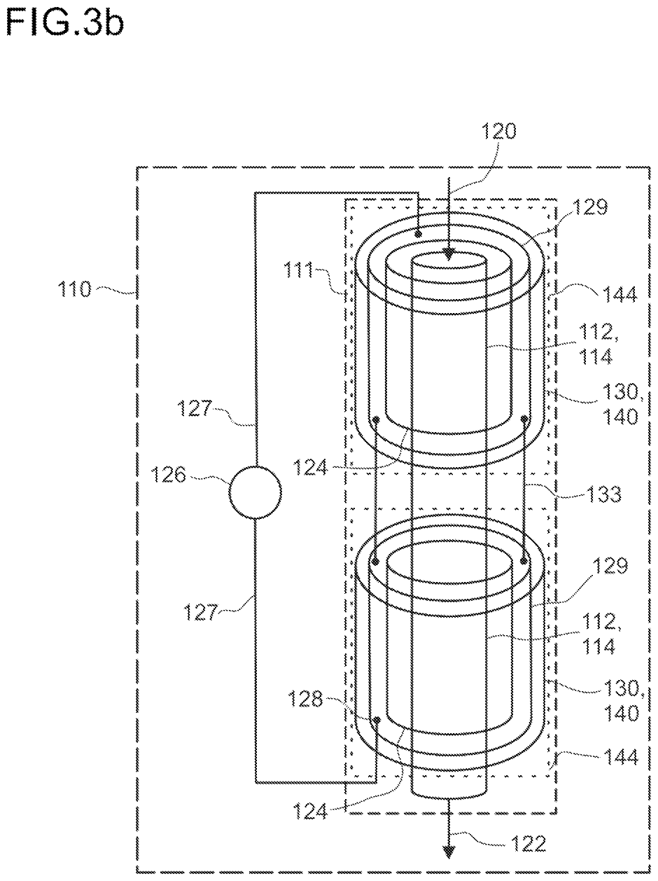

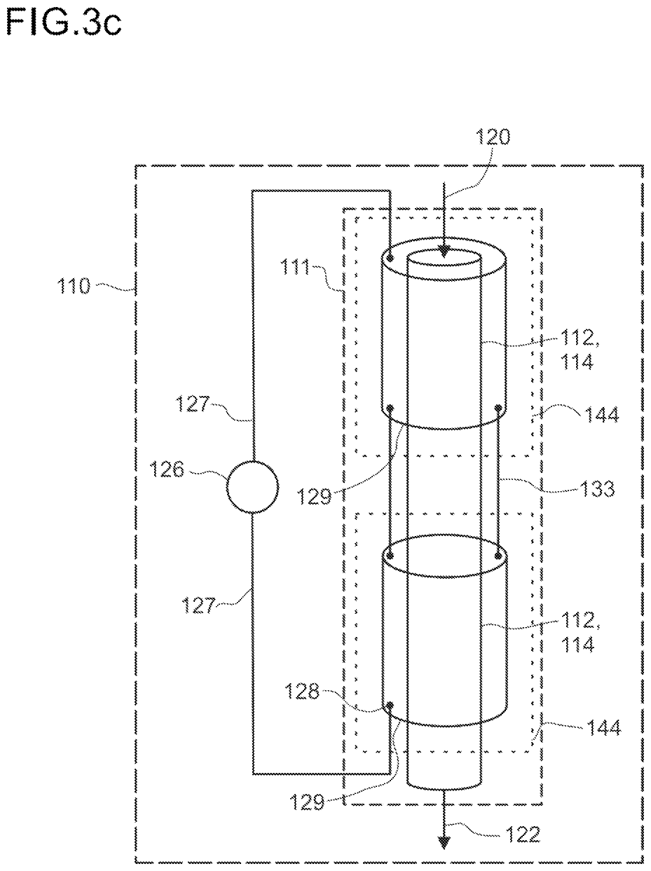

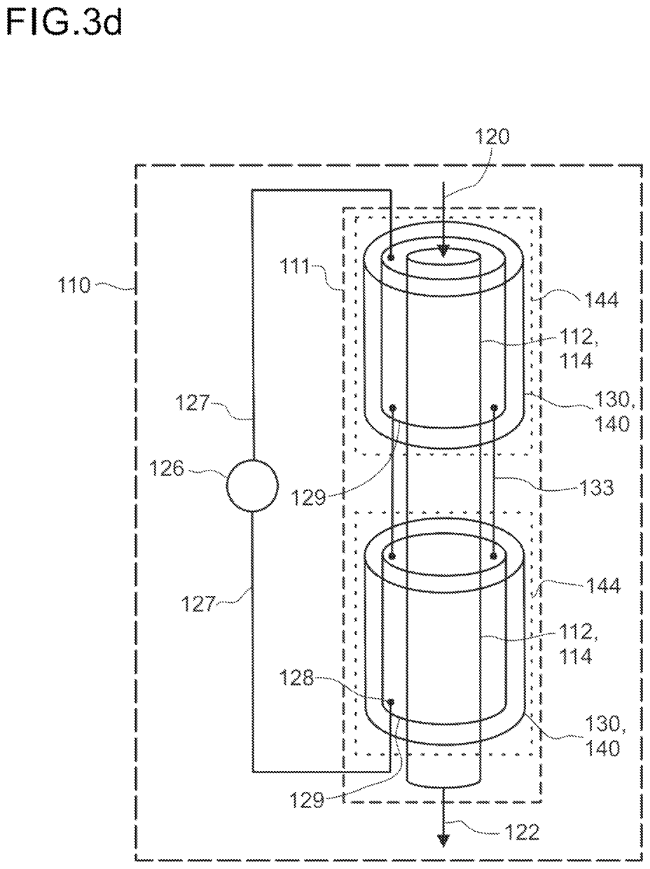

FIGS. 3a to 3d show embodiments of the inventive device 110 comprising a multitude of two heating zones 144, in this case exactly two heating zones 144. Each heating zone 144 may comprise at least one heating cylinder 129. The heating cylinders 129 may be connected by electrical connections 133. The device 110 may also have regions in which there is no heating of the feedstock, for example mere transport zones.

FIG. 3a shows an embodiment analogous to the embodiment in FIG. 1a, but now with two heating zones 144 each having one heating cylinder 129. The two heating cylinders 129 are supplied by a common power source/voltage source 126. FIG. 3b shows an embodiment likewise with two heating zones 144, analogously to FIG. 3a, in which embodiment an outer cylinder 130 is additionally provided for each heating cylinder 129. The outer cylinder 130 may be a thermal insulator 140 for outer thermal insulation. FIG. 3c shows an embodiment similar to the embodiment of FIG. 3a, with use of an electrically nonconductive fluid cylinder 112, for example made of ceramic, in FIG. 3c. A common power or voltage source 126 is provided. FIG. 3d shows an embodiment likewise with two heating zones 144, analogously to FIG. 3c, in which embodiment an outer cylinder 130 is additionally provided for each heating cylinder 129. The outer cylinder 130 may be a thermal insulator 140 for outer thermal insulation.

The device 110 may have a multitude of power sources and/or voltage sources 126, said power sources and/or voltage sources 126 being selected from the group consisting of: single-phase or multiphase AC power sources and/or single-phase or multiphase AC voltage sources, or DC power sources and/or DC voltage sources, and a combination thereof. The device 110 may have 2 to M different power sources and/or voltage sources 126, where M is a natural number not less than three. The power sources and/or voltage sources 126 may be configured with or without the possibility of controlling at least one electrical output variable. The power sources and/or voltage sources 126 may be electrically controllable independently of one another. The power sources and/or voltage sources 126 may be of identical or different configuration. For example, the device 110 may be set up such that current and/or voltage are adjustable for different zones of the device 110, especially of the heating cylinder(s) 129. The device 110 may have a multitude of fluid cylinders 112. Fluid cylinders 112 may share a common heating cylinder 129 or each have an assigned heating cylinder 129. The fluid cylinders 112 may belong to different temperature regions or zones. The fluid cylinders 112 themselves may likewise have temperature zones. The individual fluid cylinders 112 may be assigned one or more power sources or voltage sources 126. The power supply and/or voltage supply may, for example, be adjusted by use of at least one controller, in each case depending on the reaction and methodology. Using a multitude of power sources and/or voltage sources 126 allows the voltage in particular to be varied for different zones. For instance, it is possible to achieve not too high a current, which would result in excessively hot fluid cylinders 112 or, conversely, excessively cold fluid cylinders 112.

The device 110 may have a multitude of single-phase or multiphase AC power sources or AC voltage sources. The fluid cylinders 112 may each be assigned at least one heating cylinder 129 with at least one AC power source and/or AC voltage source connected to the heating cylinder 129, especially electrically via at least one electrical connection. Also conceivable are embodiments in which at least two fluid cylinders 112 share a heating cylinder 129 and an AC power source and/or AC voltage source. For connection of the AC power source or AC voltage source and the heating cylinders 129, the electrically heatable reactor may have 2 to N inputs and outputs 127, where N is a natural number not less than three. The respective AC power source and/or AC voltage source may be set up to generate an electrical current in the respective heating cylinder 129. The AC power sources and/or AC voltage sources may either be controlled or uncontrolled. The AC power sources and/or AC voltage sources may be configured with or without the possibility of controlling at least one electrical output variable. The device 110 may have 2 to M different AC power sources and/or AC voltage sources, where M is a natural number not less than three. The AC power sources and/or AC voltage sources may be independently electrically controllable. For example, a different current may be generated in the respective heating cylinder 129 and different temperatures reached in the fluid cylinders 112.

The device 110 may comprise a multitude of DC power sources and/or DC voltage sources. Each fluid cylinder 112 may be assigned at least one heating cylinder 129 and at least one DC power source and/or DC voltage source connected to the heating cylinder 129, especially electrically via at least one electrical connection. Also conceivable are embodiments in which at least two fluid cylinders 112 share a heating cylinder 129 and a DC power source and/or DC voltage source. For connection of the DC current sources and/or DC voltage sources and the heating cylinder 129, the device may have 2 to N positive terminals and/or conductors and 2 to N negative terminals and/or conductors, where N is a natural number not less than three. The respective DC power source and/or DC voltage source may be set up to generate an electrical current in the respective heating cylinder 129. The current generated can heat the respective fluid cylinder by Joule heat that arises on passage of the electrical current through the heating cylinder 129, in order to heat the feedstock.

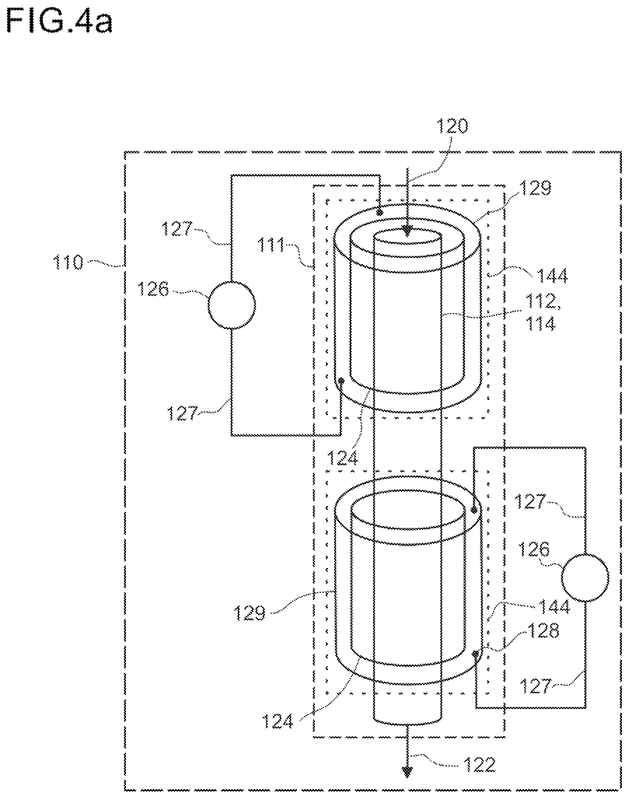

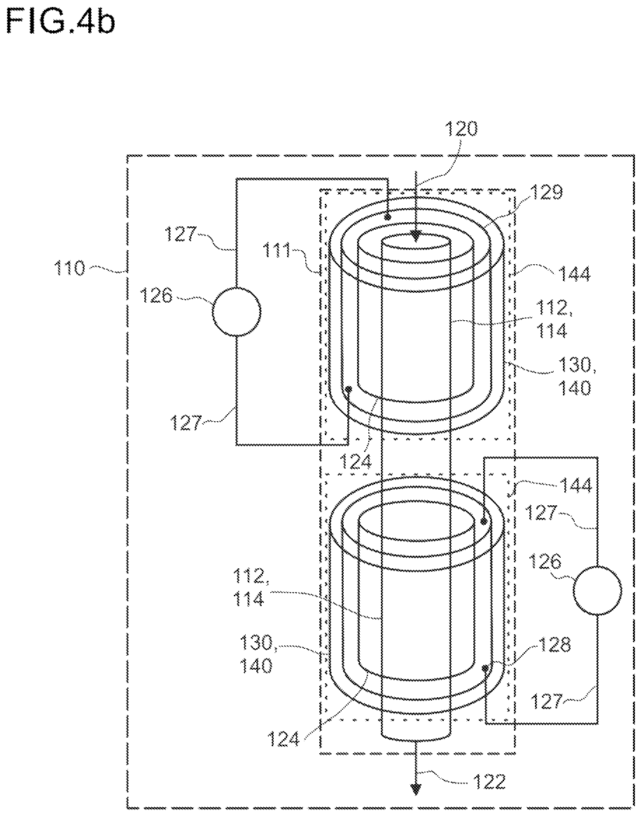

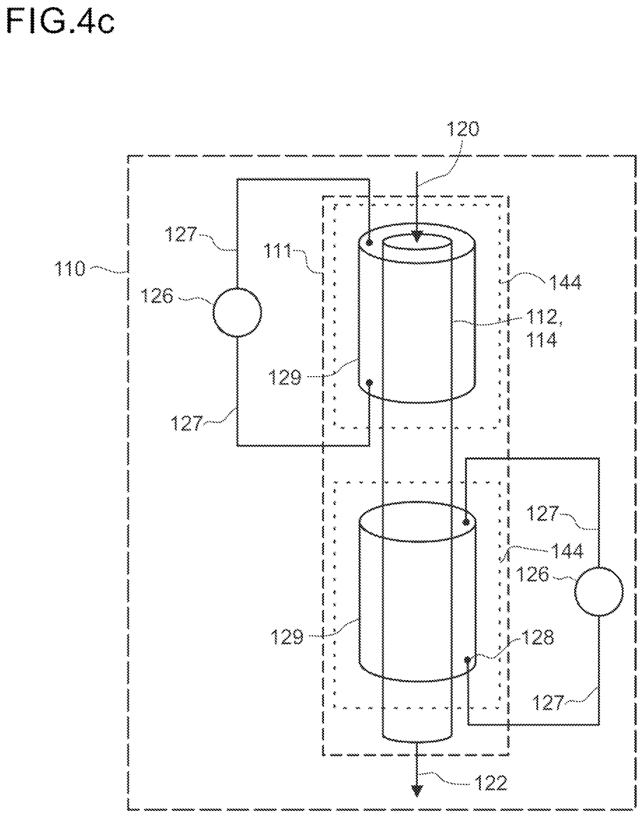

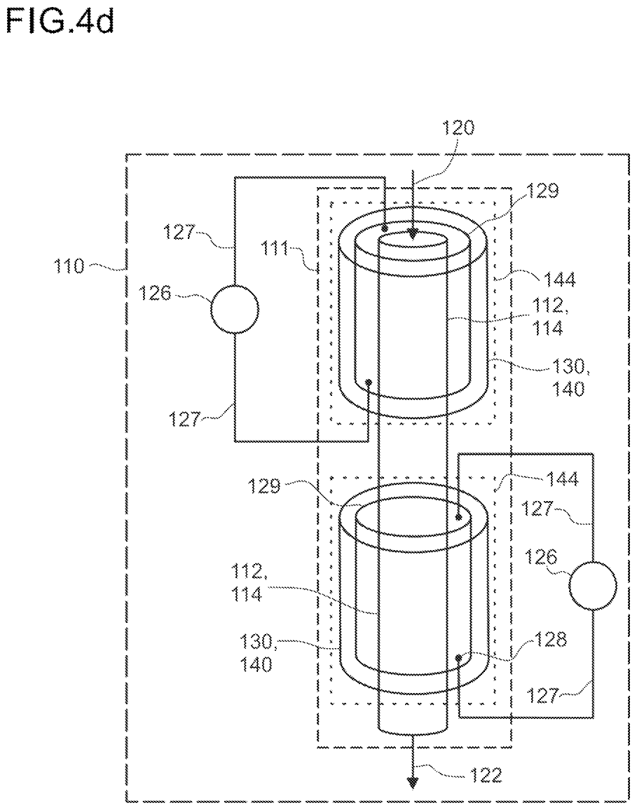

FIGS. 4a to 4d show further embodiments of the inventive device 110 having two heating zones 144 and a multitude of power sources or voltage sources 126. FIG. 4a shows an embodiment with two heating zones 144, in which embodiment two power sources or voltage sources 126 are provided. This may enable different charging of the heating cylinders 129. For instance, different temperatures can be enabled in different heating zones 144 and/or closed-loop control of the temperatures along the fluid cylinder 112. The heating cylinders 129 may have a current-conducting configuration. It is possible in each case to provide a galvanic insulator 124 having a thermally conductive and galvanically insulating configuration. In FIG. 4b, analogously to the embodiment in FIG. 4a, two power sources or voltage sources 126 are used for the heating zones 144, in which embodiment an outer cylinder 130 is additionally provided for each heating cylinder 129. The outer cylinder 130 may be a thermal insulator 140 for outer thermal insulation. FIG. 4c shows an embodiment analogous to that in FIG. 3c, but likewise with two heating zones 144 and two power sources or voltage sources 126. The heating cylinder 129 may have a current-conducting configuration. It is possible to use an electrically nonconductive fluid cylinder 112, for example ceramic. FIG. 4d shows an embodiment analogous to FIG. 4c, in which embodiment an outer cylinder 130 for outer thermal insulation is additionally provided for each heating cylinder 129.

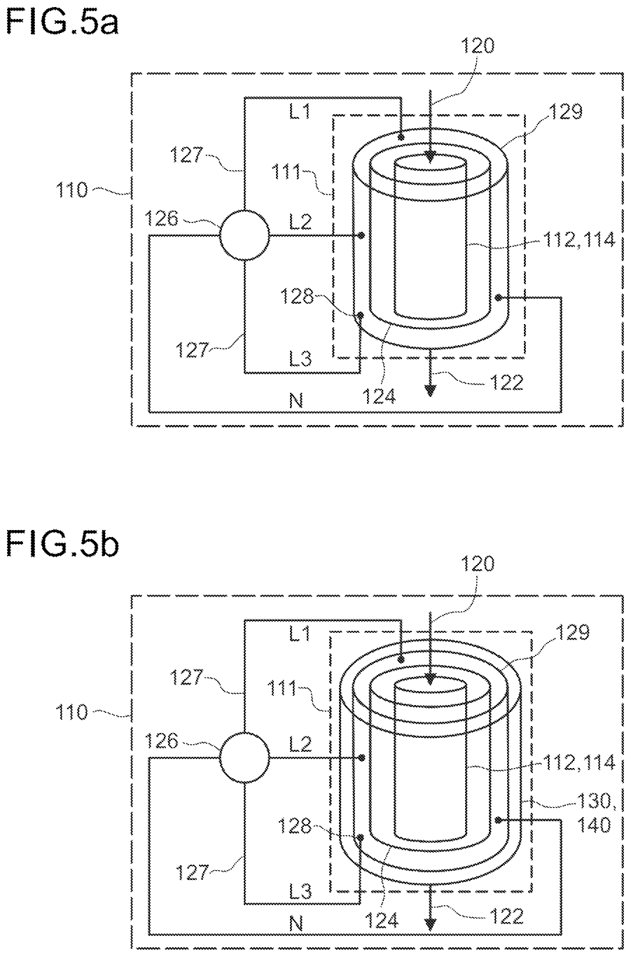

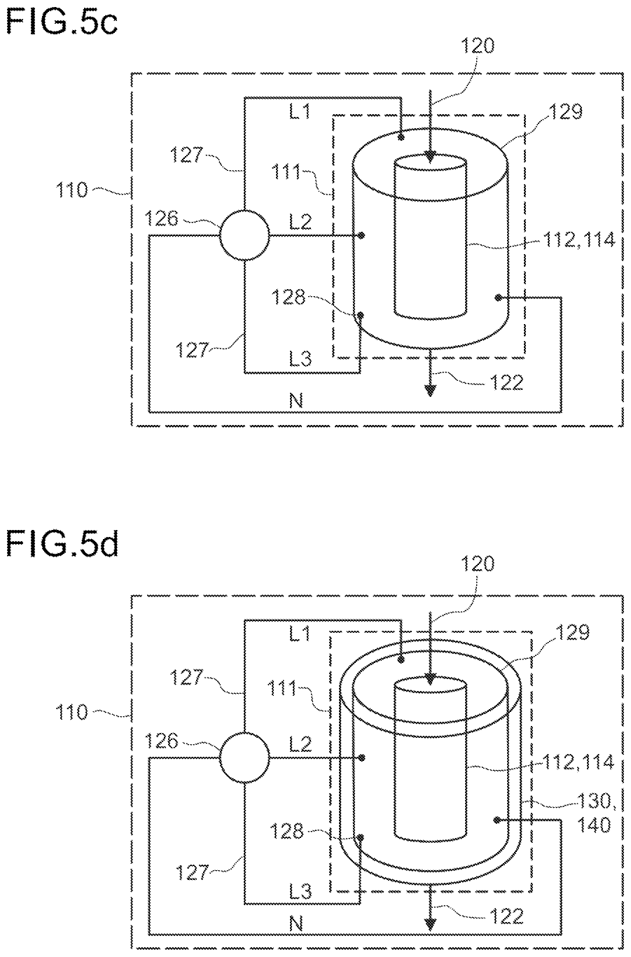

FIGS. 5a to 5d show further embodiments of the inventive device 110 with utilization of 3-phase AC power. With regard to the configuration of the device 110, reference is made to the description relating to FIG. 1a with regard to FIG. 5a, to FIG. 1b with regard to FIG. 5b, to FIG. 1c with regard to FIG. 5c, and to FIG. 1d with regard to FIG. 5d, with the particular features that follow. In these embodiments of FIGS. 5a to 5d, the device 110 has a three-phase AC power source or AC voltage source 126. The three outside conductors are labeled L1, L2 and L3, and the neutral conductor N. Also conceivable is a multiphase AC power source or AC voltage source with n×3 conductors.

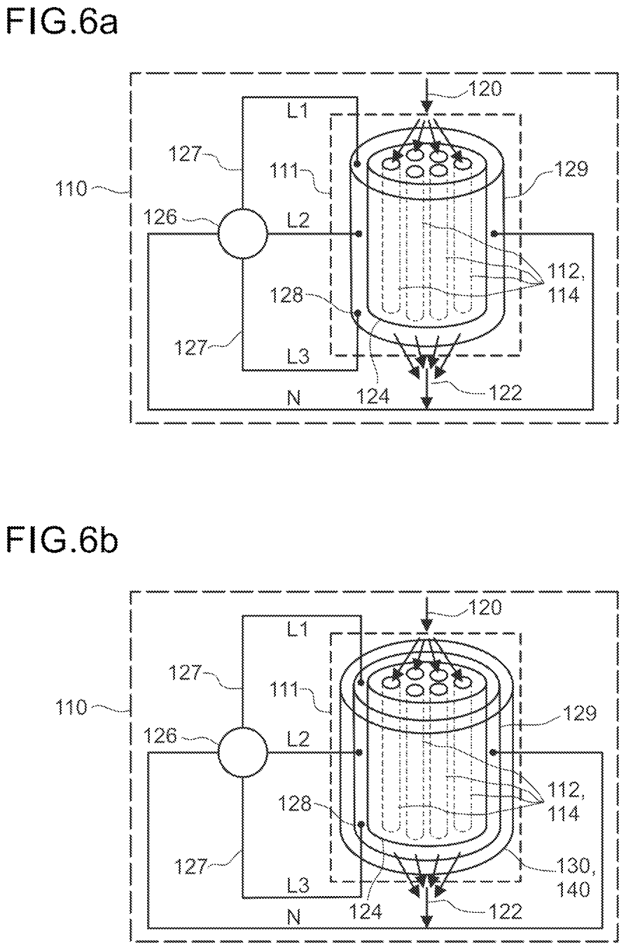

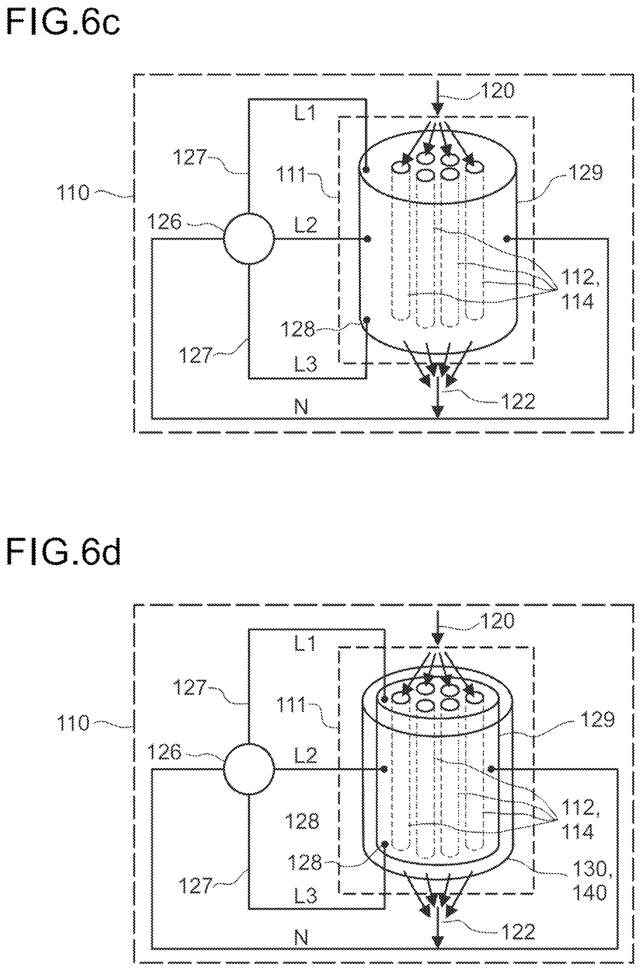

FIGS. 6a to 6d show further embodiments of the inventive device 110 with utilization of 3-phase AC power. With regard to the configuration of the device 110, reference is made to the description relating to FIG. 2a with regard to FIG. 6a, to FIG. 2b with regard to FIG. 6b, to FIG. 2c with regard to FIG. 6c, and to FIG. 2d with regard to FIG. 6d, with the particular features that follow. In these embodiments of FIGS. 6a to 6d, the device 110 has a three-phase AC power source or AC voltage source 126. The three outside conductors are again labeled L1, L2 and L3, and the neutral conductor N. Also conceivable is a multiphase AC power source or AC voltage source with n×3 conductors.

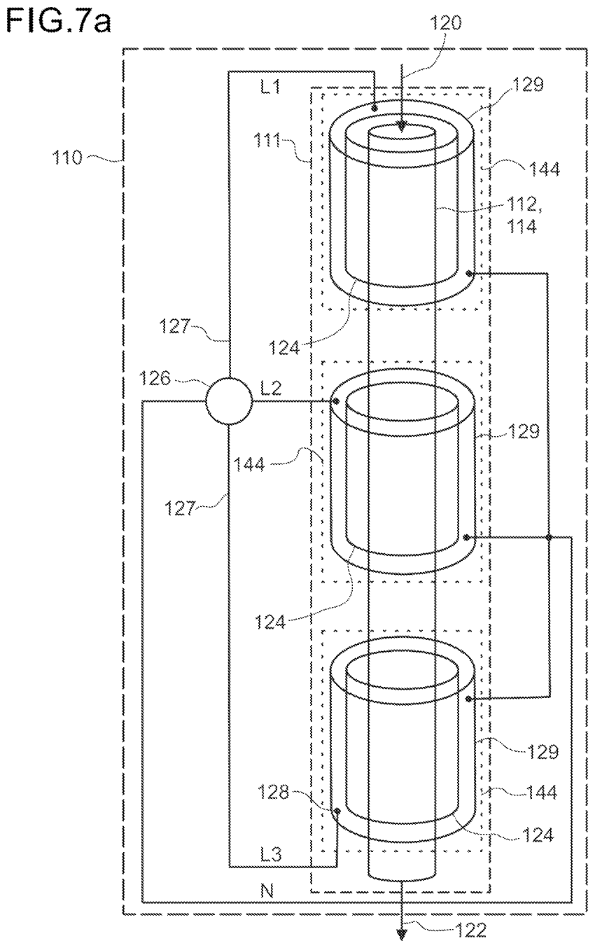

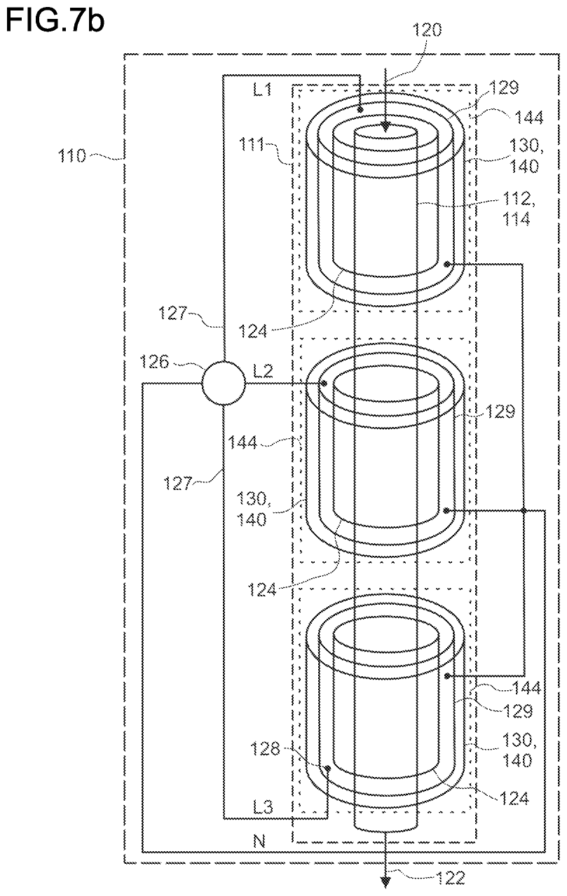

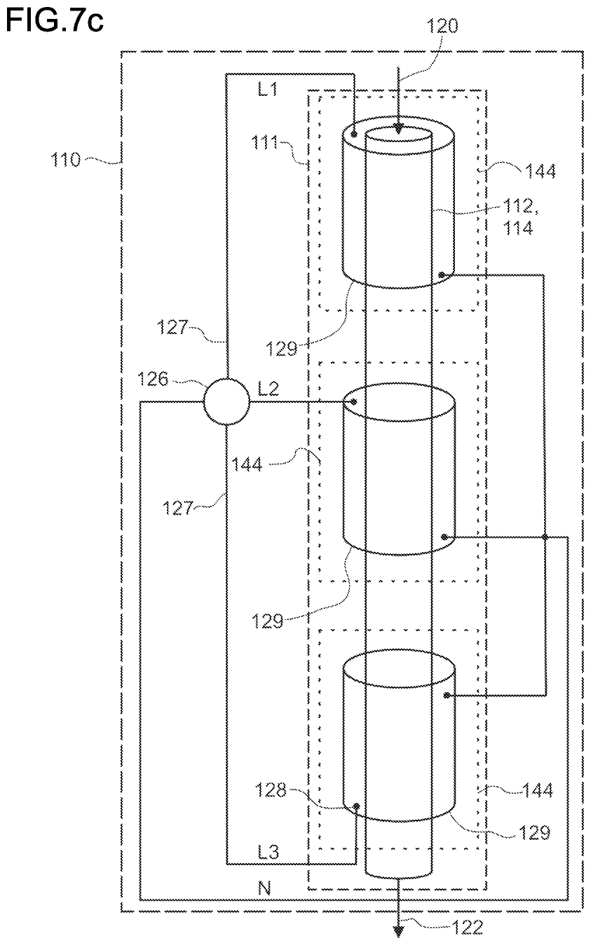

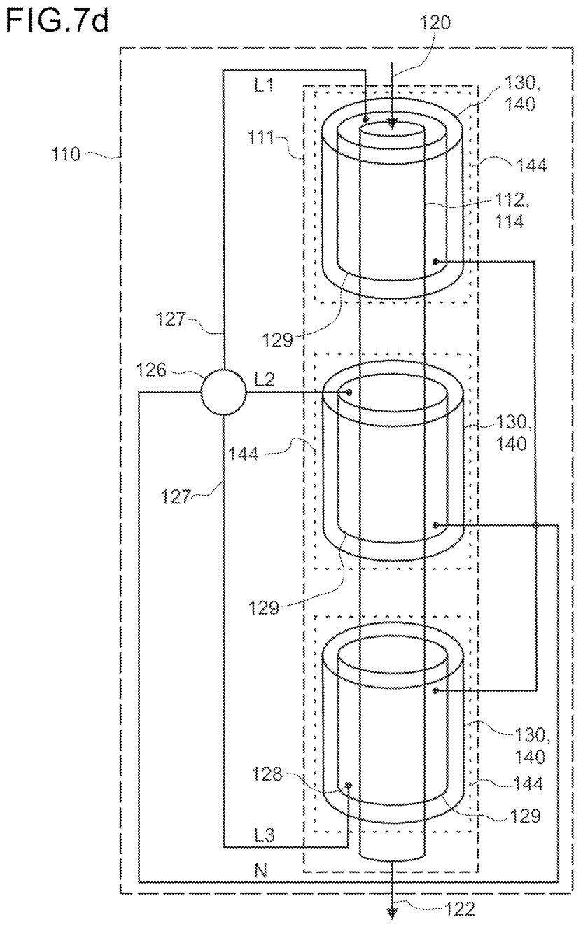

FIGS. 7a to 7d show further embodiments of the inventive device 110 with utilization of 3-phase AC power. With regard to the configuration of the device 110, reference is made to the description relating to FIG. 3a with regard to FIG. 7a. With regard to the configuration of the device 110, reference is made to the description relating to FIG. 3b with regard to FIG. 7b. With regard to the configuration of the device 110, reference is made to the description relating to FIG. 3c with regard to FIG. 7c. With regard to the configuration of the device 110, reference is made to the description relating to FIG. 3d with regard to FIG. 7d.

Three heating zones 144 with a 3-phase power source or voltage source are shown. The three outside conductors are again labeled L1, L2 and L3, and the neutral conductor N. Also conceivable is a multiphase AC power source or AC voltage source with n×3 conductors.

The device 110 may have a multitude of fluid cylinders 112. The fluid cylinders 112 may comprise symmetric and/or asymmetric pipes and/or combinations thereof. The geometry and/or surfaces and/or material of the fluid cylinder 112 may be dependent on a feedstock to be transported or else dependent on an optimization of the reaction or other factors. In a purely symmetrical configuration, the device 110 may comprise fluid cylinders 112 of an identical pipe type. The pipe type may be characterized at least by one feature selected from the group consisting of: a horizontal configuration of the pipeline; a vertical configuration of the pipeline; a length in the inlet (l1) and/or outlet (l2) and/or transition (l3); a diameter in the inlet (d1) and outlet (d2) and/or transition (d3); number n of passes; length per pass; diameter per pass; geometry; surface; and material. The device 110 may comprise a combination of at least two different pipe types which are connected in parallel and/or in series. For example, the device 110 may comprise pipelines of different lengths in the inlet (l1) and/or outlet (l2) and/or transition (l3). For example, the device 110 may comprise pipelines with an asymmetry of the diameters in the inlet (d1) and/or outlet (d2) and/or transition (d3). For example, the device 110 may comprise pipelines with a different number of passes. For example, the device 110 may comprise pipelines with passes with different lengths per pass and/or different diameters per pass. In principle, any combination of any pipe type in parallel and/or in series is conceivable.

The device 110 may comprise a multitude of inlets 120 and/or outlets 122 and/or production streams. The fluid cylinders 112 of different or identical pipe types may be arranged in parallel and/or in series with a plurality of inlets 120 and/or outlets 122. Fluid cylinders 112 may take the form of various pipe types in the form of a construction kit and may be selected and combined as desired, depending on an end use. Use of fluid cylinders 112 of different pipe types can enable more accurate temperature control and/or adjustment of the reaction when the feed is fluctuating and/or a selective yield of the reaction and/or an optimized methodology. The fluid cylinders 112 may comprise identical or different geometries and/or surfaces and/or materials.

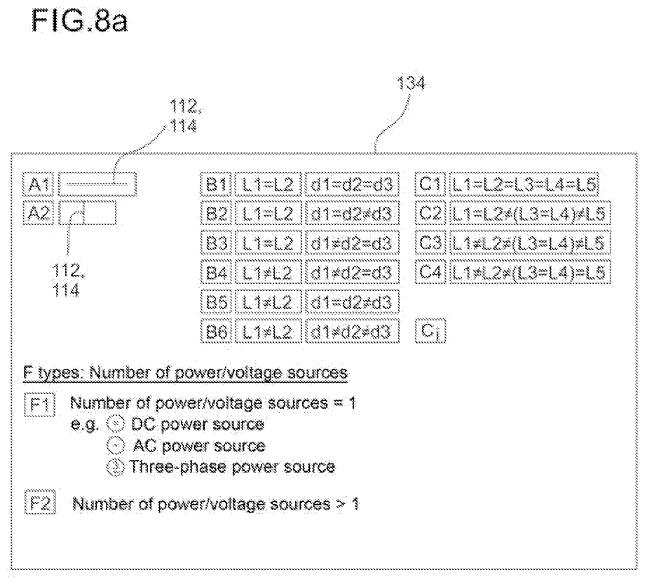

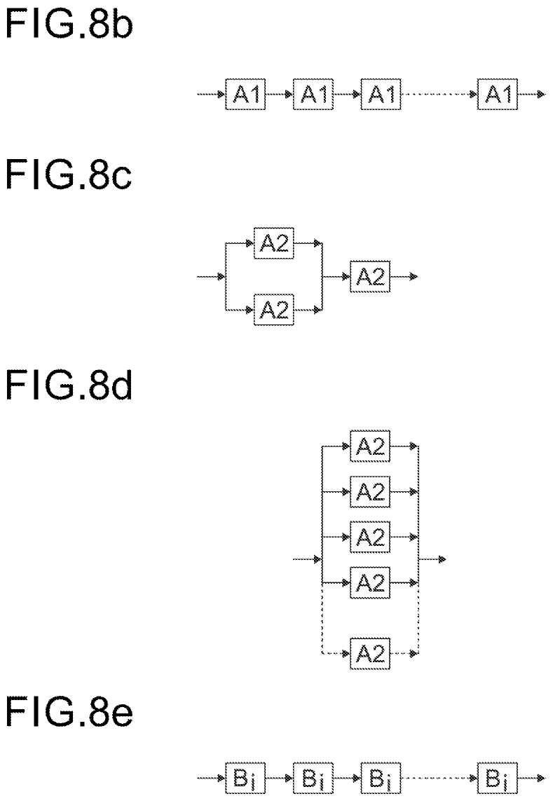

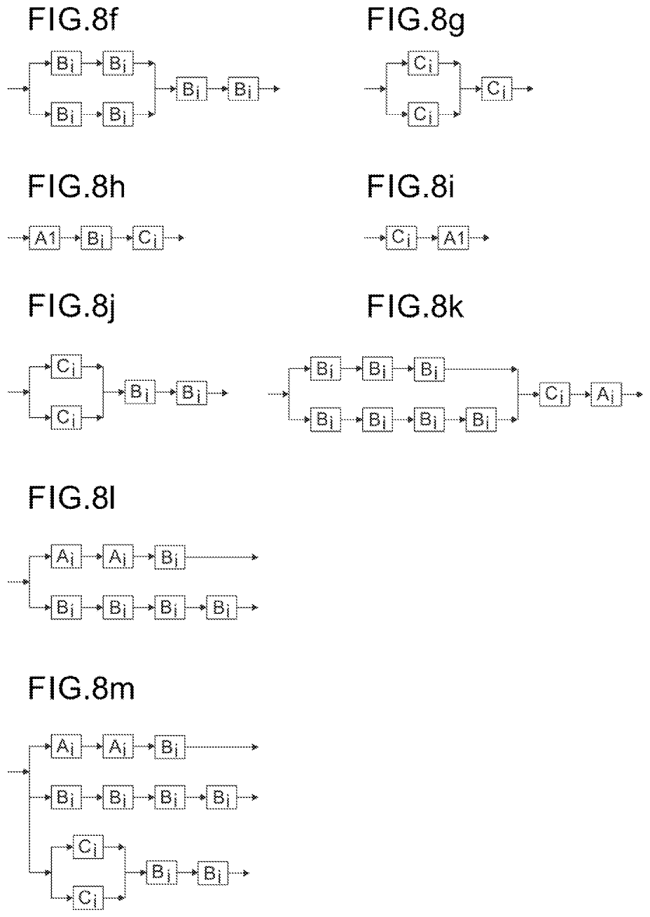

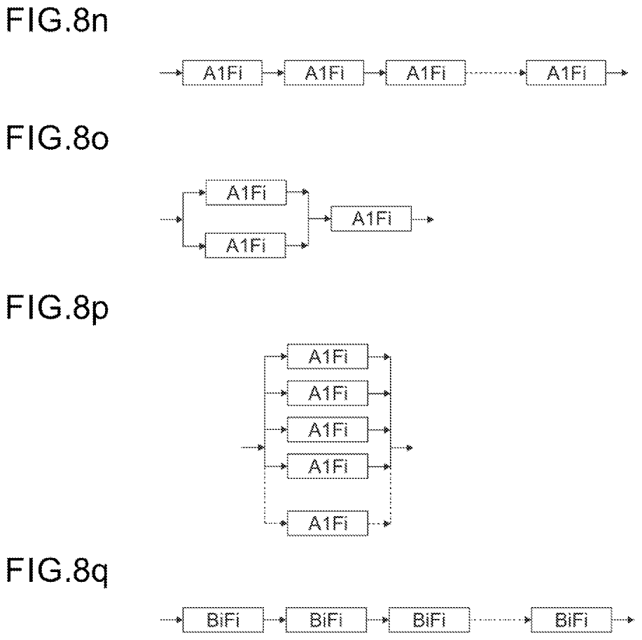

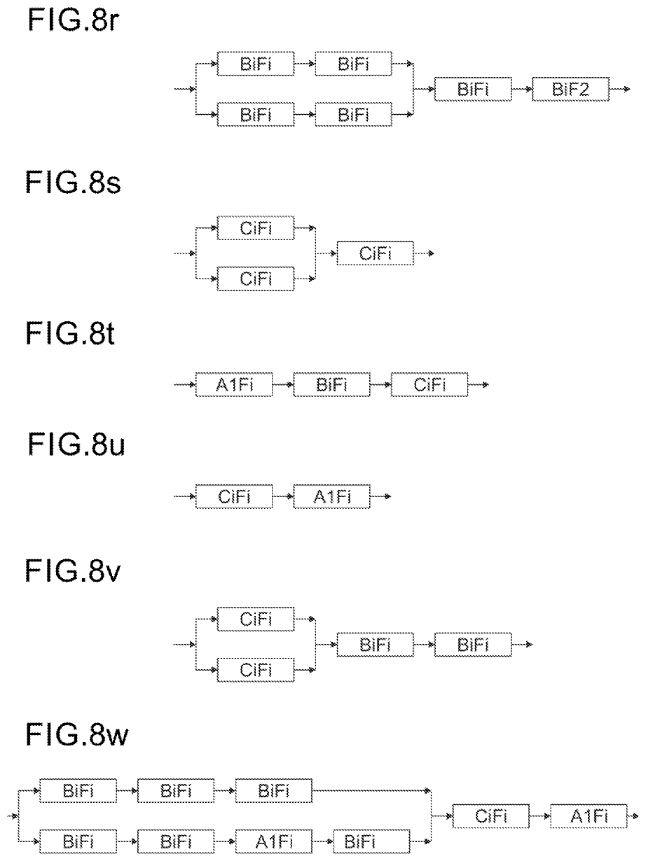

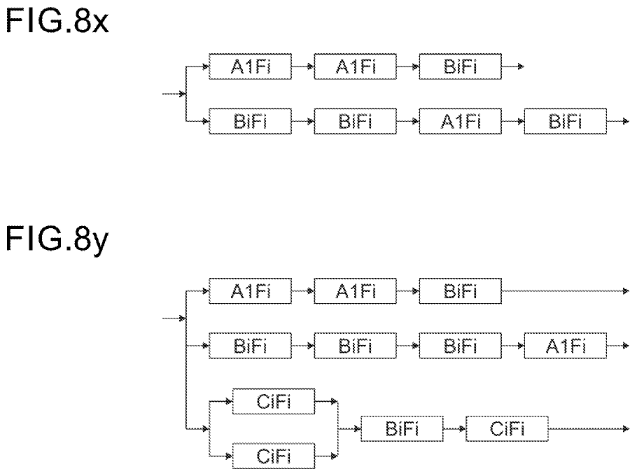

FIGS. 8 to 8y show possible embodiments by way of example of pipe or cylinder types in a schematic diagram. This pipe type can be divided into the following categories, with all conceivable combinations of categories being possible:
Category A indicates a course of the fluid cylinder 112 and/or a fluid cylinder segment 114, where A1 denotes a pipe or cylinder type with a horizontal course and A2 a pipe type with a vertical course, i.e. a course perpendicular to the horizontal course.
Category B specifies a ratio of lengths in the inlet (l1) and/or outlet (l2) and/or diameter in the inlet (d1) and/or outlet (d2) and/or transition (d3), with six different possible combinations provided in the construction kit 134.
Category C indicates ratios of lengths in the inlet (l1) and/or outlet (l2) and lengths of passes. All combinations are conceivable here, which are labeled Ci in the present case.
Category F includes the number of electrodes: F1 indicates that a number of electrodes is ≤2, for example in the case of a DC power source or an AC power source. F2 indicates that a number of electrodes is >2, for example for a three-phase power source.

FIGS. 8b to 8y show inventive working examples of combinations of fluid cylinders 112 and/or fluid cylinder segments 114 of the same and/or different pipe type. FIG. 8b shows a combination of fluid cylinders 112 with three horizontal pipelines 112 and/or pipeline segments 114 of pipe type A1, arranged in succession. FIG. 8c shows two vertical pipes of pipe type A2 connected in parallel and one downstream pipeline 112 and/or one downstream pipeline segment 114, likewise of pipe type A2. FIG. 8d shows a multitude of pipelines 112 and/or pipeline segments 114 of pipe type A2, which are all connected in parallel. FIG. 8e shows an embodiment in which a multitude of pipe types of category B are arranged in succession. The pipelines 112 and/or pipeline segments 114 here may be identical or different pipe types of category B, identified by Bi. FIG. 8f shows an embodiment with six pipelines 112 and/or pipeline segments 114 of category B, with arrangement in two parallel strands of in each case two pipelines 112 and/or pipeline segments 114 and with two further pipelines 112 and/or pipeline segments 114 connected downstream. FIG. 8g shows an embodiment with pipelines 112 and/or pipeline segments 114 of category C, with parallel connection of two pipelines 112 and/or pipeline segments 114 and with one pipeline 112 and/or one pipeline segment 114 connected downstream. Also possible are mixed forms of categories A, B and C, as shown in FIGS. 8h to 8m.

The device 110 may have a multitude of feed inlets and/or feed outlets and/or production streams. The pipelines 112 and/or pipeline segments 114 of different or identical pipe type may be arranged in parallel and/or in series with a plurality of feed inlets and/or feed outlets, as shown for example in FIGS. 8k and 8m. FIGS. 8n to 8p show illustrative combinations of pipelines 112 and/or of pipeline segments 114 of categories A and Fi. FIGS. 8q and 8r show illustrative combinations of pipelines 112 and/or of pipeline segments 114 of categories B and Fi. FIG. 8s shows an illustrative combination of pipelines 112 and/or of pipeline segments 114 of categories C and Fi. FIG. 8t shows an illustrative combination of pipelines 112 and/or of pipeline segments 114 of categories A, B, C and Fi. FIG. 8u shows an illustrative combination of pipelines 112 and/or of pipeline segments 114 of categories A, C and Fi. FIG. 8v shows an illustrative combination of pipelines 112 and/or of pipeline segments 114 of categories B, C and Fi. FIGS. 8w and 8y show illustrative combinations of pipelines 112 and/or of pipeline segments 114 of categories A, B, C and Fi. FIG. 8x shows an illustrative combination of pipelines 112 and/or of pipeline segments 114 of categories A, B and Fi. The device 110 may have a multitude of feed inlets and/or feed outlets and/or production streams. The pipelines 112 and/or pipeline segments 114 of different or identical pipe types of categories A, B, C and Fi may be arranged in parallel and/or in series with a plurality of feed inlets and/or feed outlets. Examples of a multitude of feed inlets and/or feed outlets and/or production streams are shown in FIGS. 8o, 8p, 8r, 8s, 8v to 8y. The lines may represent the feed stream or fluid stream, but they may also indicate the electrical connections.

Use of fluid cylinders 112 and/or fluid cylinder segments 114 of different pipe types can enable more accurate temperature control and/or adjustment of the reaction when there is a fluctuating feed and/or a selective yield of the reaction and/or an optimized methodology.

The device 110 may have at least one temperature sensor 145 set up to determine a temperature of the fluid cylinder 112. The temperature sensor 145 may comprise an electrical or electronic element set up to generate an electrical signal as a function of temperature. For example, the temperature sensor 145 may have at least one element selected from the group consisting of: a high-temperature conductor, a low-temperature conductor, a semiconductor temperature sensor, a temperature sensor with an oscillating crystal, a thermocouple, a pyroelectric material, a pyrometer, a thermal imaging camera, a ferromagnetic temperature sensor, a fiber-optical temperature sensor 145.

The device 110 may have at least one controller unit set up to control the power source or voltage source 126 by closed-loop control as a function of a temperature measured by the temperature sensor 145. The device 110 may comprise an online temperature measurement, especially a measurement of the temperature by the at least one temperature sensor 145 which is made during the transport and/or the reaction of the feedstock in the fluid cylinder 112. For instance, closed-loop control of the temperature during operation is possible. In particular, a temperature measurement and closed-loop control can be effected over a length of the reactor.

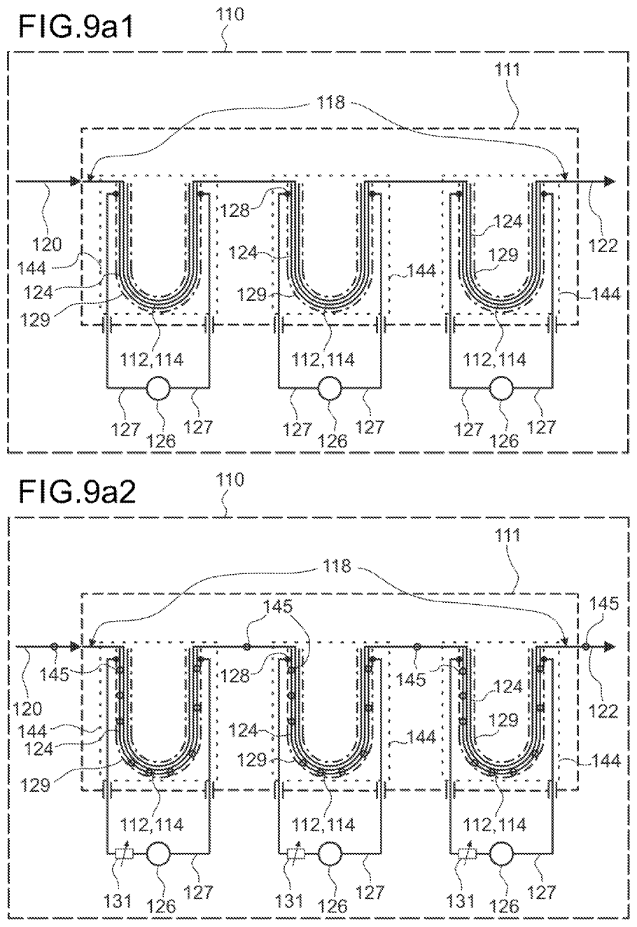

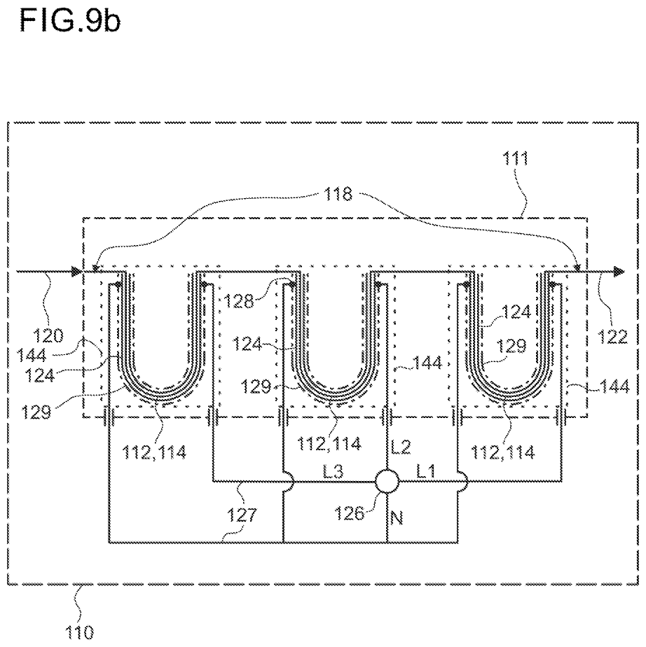

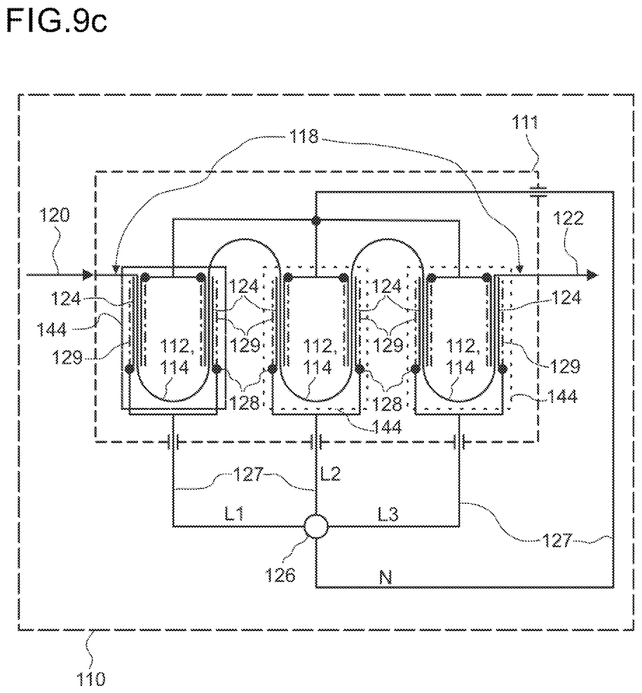

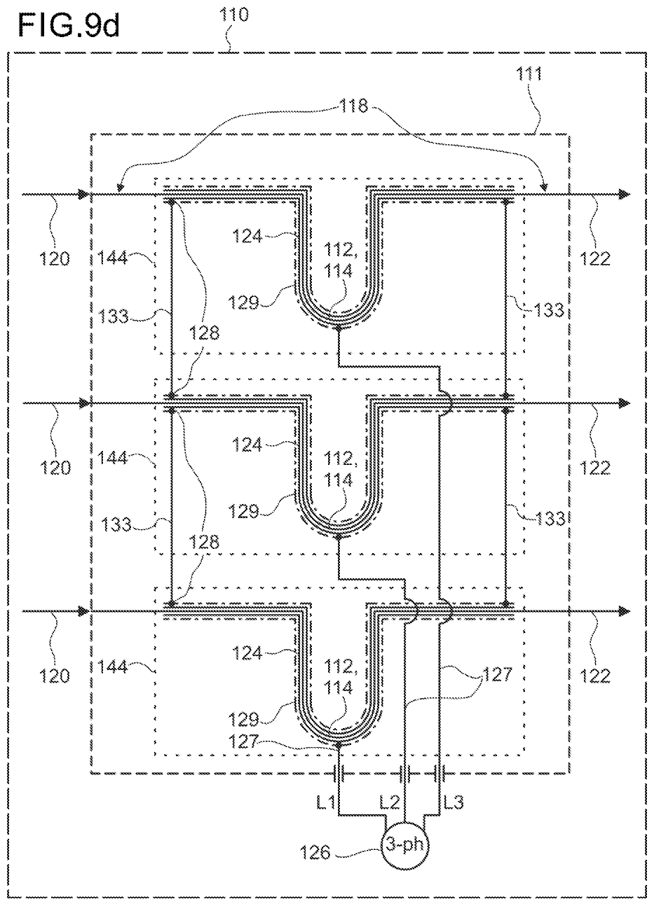

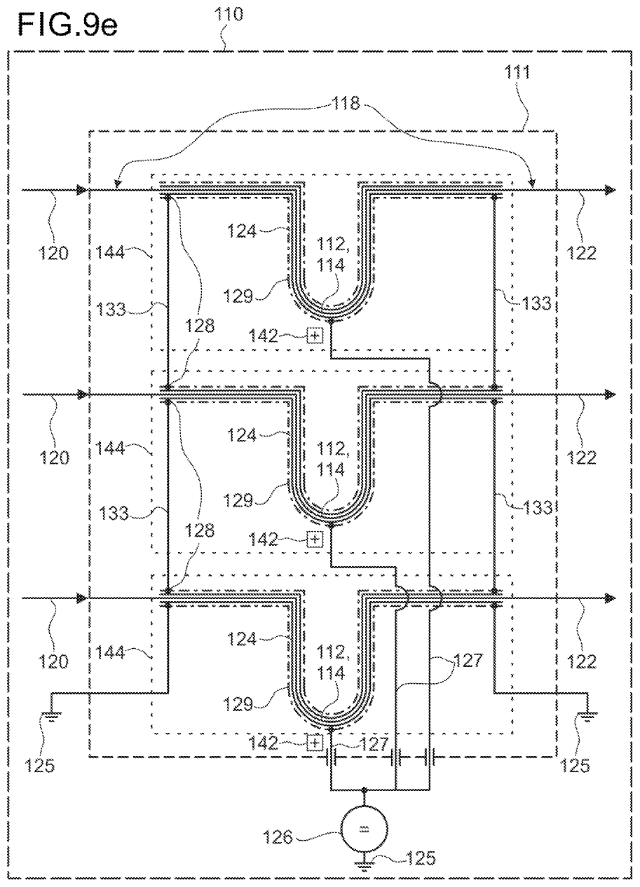

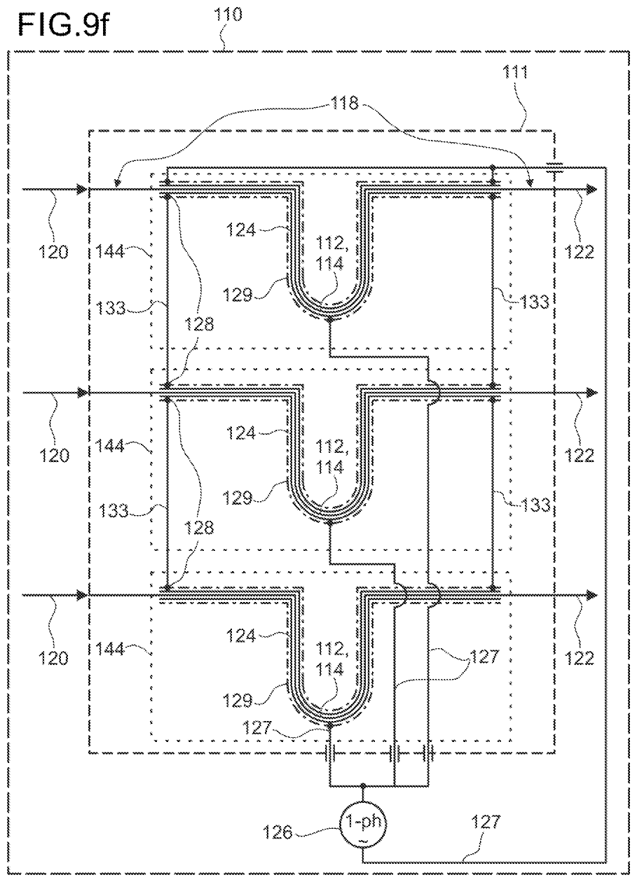

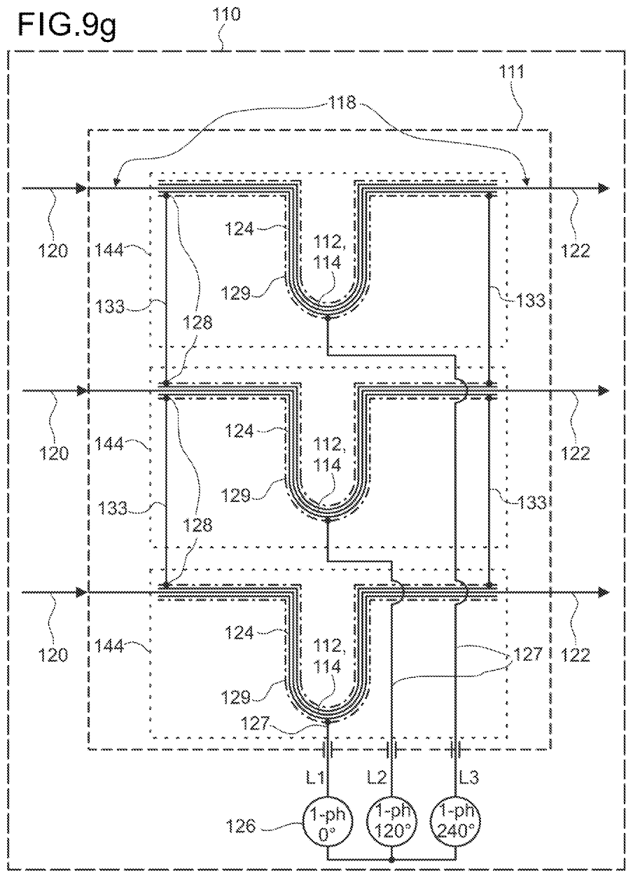

FIGS. 9a1 to 9g show further embodiments of the inventive device 110. With regard to the configuration of the device 110 in FIG. 9a1 or 9a2, reference is made to the description relating to FIG. 4a. The heating cylinder 129 in this embodiment may be current-conducting. The device may include the galvanic insulator 124, which has a thermally conductive and galvanically insulating configuration. The fluid cylinders 112, 114 may be a “U”-shaped tube. The device 110 may have three heating zones 144 with three 1-phase power sources or voltage sources 126 without closed-loop control. FIG. 9a2 shows an embodiment analogously to FIG. 9a1, in which embodiment three 1-phase power sources or voltage sources 126 with closed-loop control 131 and temperature sensors 145 are provided. FIG. 9b shows an embodiment analogously to FIG. 9a1, in which embodiment one 3-phase power source or voltage source 126 without a star bridge in the reactor. FIG. 9c shows an embodiment analogously to FIG. 9a1, in which embodiment one 3-phase power source or voltage source 126 with a star bridge in the reactor is provided.

FIGS. 9d to 9g show embodiments with a triple fluid cylinder 112, 114. The fluid cylinders 112, 114 may be three mutually separate “U”-shaped tubes. The respective heating cylinder 129 may have a current-conducting configuration. The device may include the galvanic insulator 124, which has a thermally conductive and galvanically insulating configuration. FIG. 9d shows a utilization of 3-phase AC power. FIG. 9e shows a utilization of DC power. Positive terminals/conductors are indicated by reference numeral 142. Ground is indicated by reference numeral 125. FIG. 9f shows a utilization of 1-phase AC power. FIG. 9g shows a utilization of three 1-phase power sources or voltage sources 126, which are shifted by 120° relative to one another for electrical purposes.

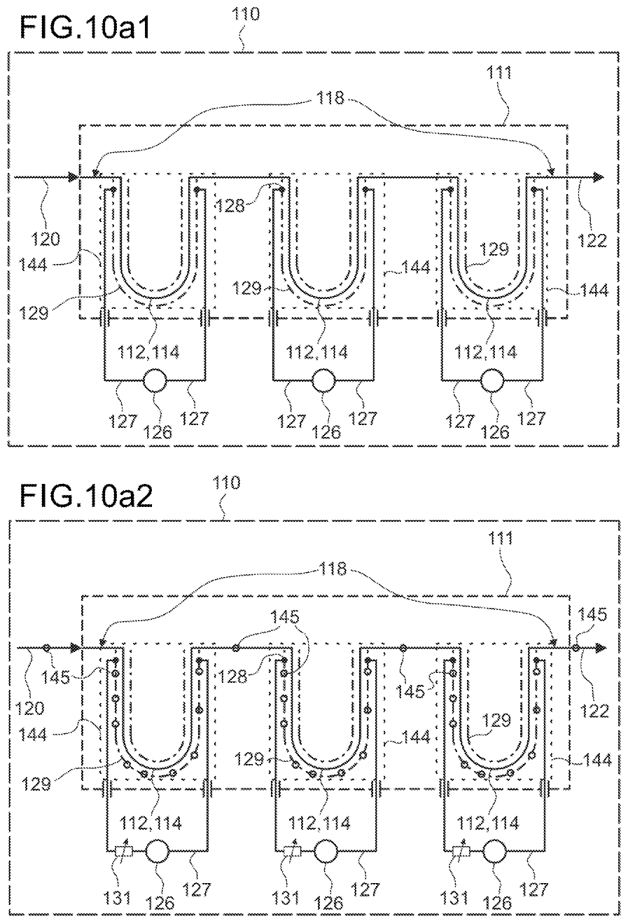

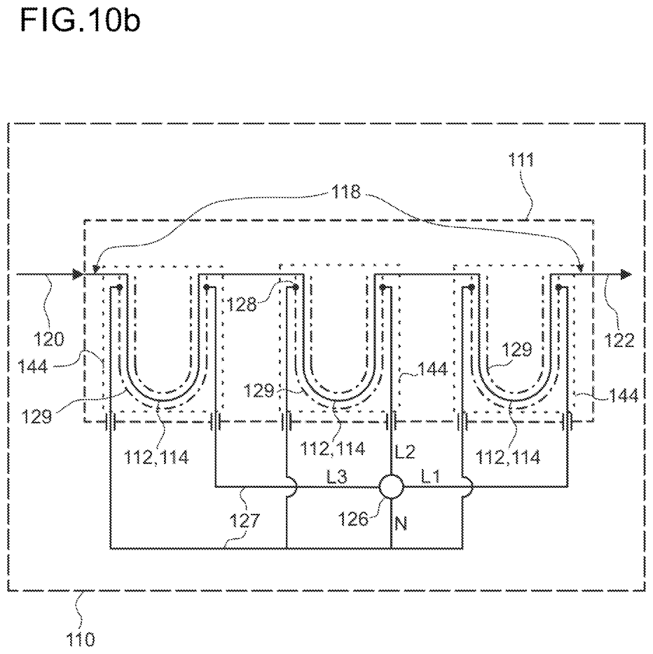

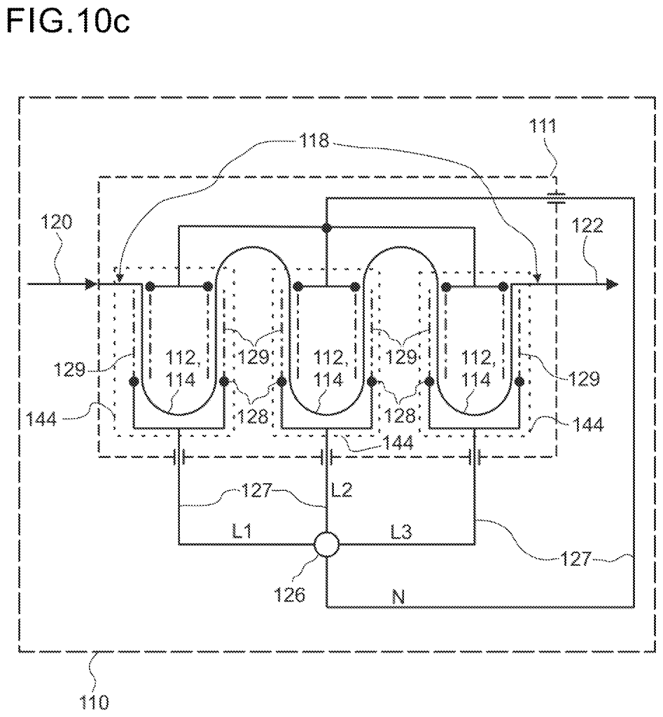

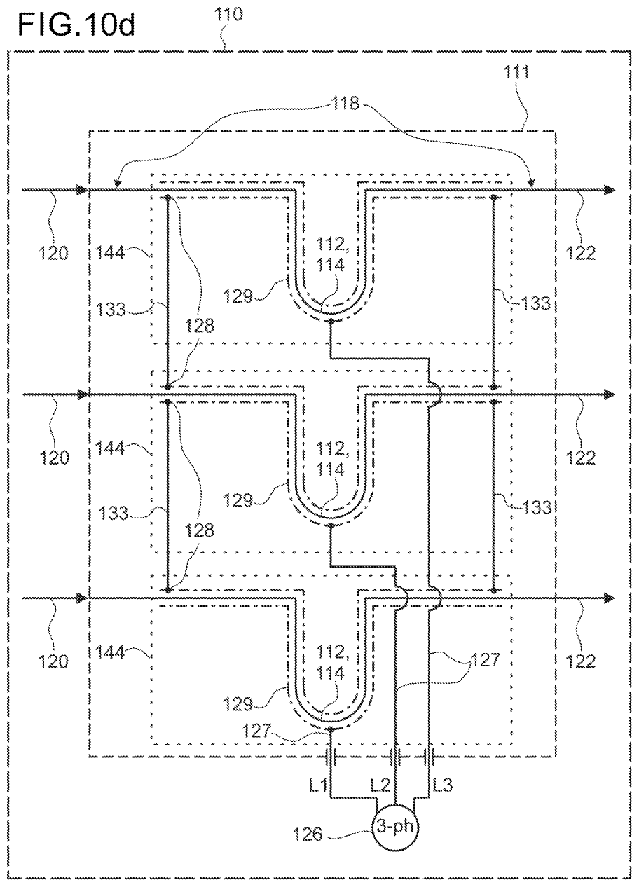

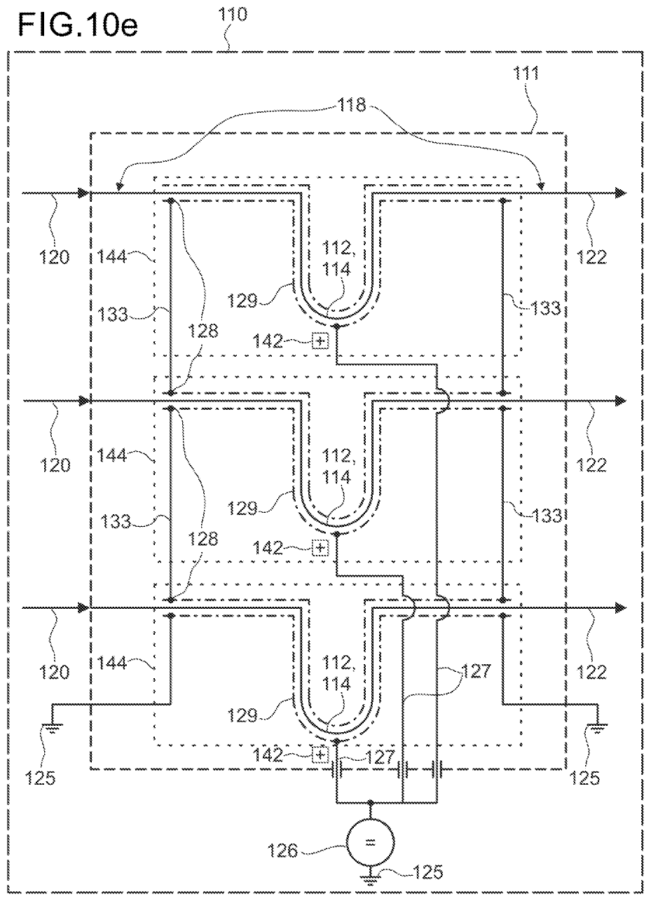

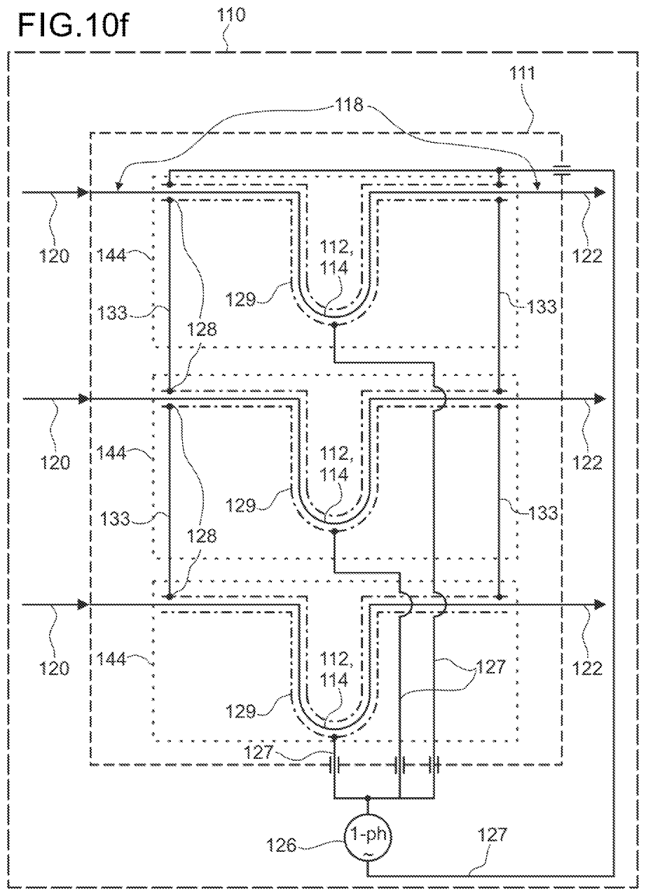

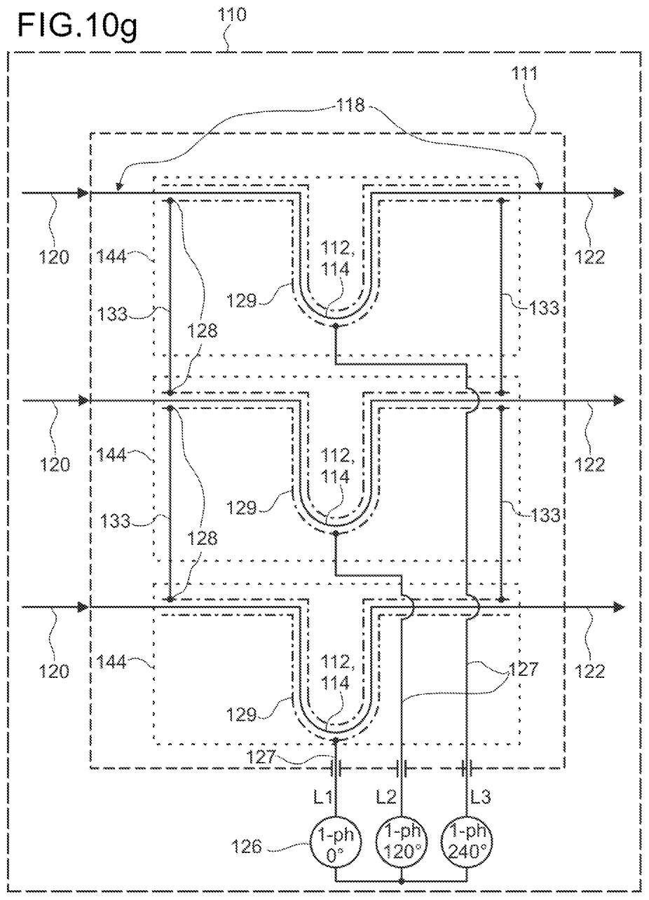

FIG. 10 show further embodiments of the inventive device 110, for example a reactor.

FIGS. 10a1 and 10a2 show embodiments analogous to FIG. 4c. The heating cylinder 129 in this embodiment may be current-conducting. The device may include the galvanic insulator 124, which has a thermally conductive and galvanically insulating configuration.

The fluid cylinder 112, 114 may be configured as a galvanically nonconductive “U”-shaped tube, for example made of ceramic. The device 110 may, as shown in FIG. 10a1, have three heating zones 144 with three 1-phase power sources or voltage sources 126 without closed-loop control. The device 110 may, as shown in FIG. 10a1, have three heating zones 144 with three 1-phase power sources or voltage sources 126 with closed-loop control. FIG. 10a2 shows an embodiment analogously to FIG. 10a1, in which embodiment three 1-phase power sources or voltage sources 126 with closed-loop control 131 and temperature sensors 145 are provided.

FIG. 10b shows an embodiment with a double cylinder composed of heating cylinder 129 and fluid cylinders 112, 114. The heating cylinder 129 in this embodiment may be current-conducting. The fluid cylinder 112, 114 may be a “U”-shaped, galvanically nonconductive pipe, for example made of ceramic. The device 110 may have three heating zones 144 one 3-phase power source or voltage source 126 without a star bridge in the reactor. In FIG. 10c is a similar device 110, with provision here of three heating zones 144 with a 3-phase power source or voltage source 126 with a star bridge in the reactor.

FIG. 10d shows an embodiment with a double cylinder composed of heating cylinder 129 and fluid cylinders 112, 114. The heating cylinder 129 in this embodiment may be current-conducting. The fluid cylinder 112, 114 may be configured as three separate galvanically nonconductive “U”-shaped pipes. FIG. 10d shows a utilization of 3-phase AC power. FIG. 10e shows an analogous device 110, but with utilization of DC current. FIG. 10f shows an analogous device 110, but with utilization of 1-phase AC current. FIG. 10g shows an analogous device 110, but with utilization of three 1-phase power sources or voltage sources 126, which are shifted by 120° relative to one another for electrical purposes.

### LIST OF REFERENCE NUMERALS

110 device
111 reactive space or heater
112 fluid cylinder
114 fluid cylinder segment
118 pipe system
120 inlet
122 outlet
124 galvanic insulator
125 ground
126 voltage/power source
127 electrical input and output
128 electrical terminals
129 heating cylinder
130 outer cylinder
131 closed-loop control
133 electrical connection
134 construction kit
140 thermal insulator
142 positive terminal/conductor
144 heating zone
145 temperature sensor

1.-13. (canceled)

14. A device comprising a multitude of hollow cylinder pipes, wherein at least one of the hollow cylinder pipes is set up as a fluid cylinder to receive at least one feedstock, wherein at least one further hollow cylinder pipe is configured as a current-conducting heating cylinder,
wherein the heating cylinder is arranged such that the heating cylinder surrounds the fluid cylinder, wherein the device has at least one power source or voltage source set up to generate an electrical current in the heating cylinder that heats the fluid cylinder by means of Joule heat that arises on passage of the electrical current through the heating cylinder, wherein the device is set up to heat the feedstock to a temperature of at least 400° C.,
wherein the heating cylinder is arranged such that the heating cylinder directly surrounds the fluid cylinder and is set up to release its current-generated heat to the fluid cylinder, or wherein the device has at least one galvanic insulator, wherein the galvanic insulator is disposed between the fluid cylinder and the heating cylinder, wherein the galvanic insulator is set up to galvanically insulate the fluid cylinder from the heating cylinder and to transfer heat from the heating cylinder to the fluid cylinder.

15. The device according to claim 14, wherein the device is set up to heat the feedstock to a temperature in the range from 400° C. to 1700° C.

16. The device according to claim 14, wherein the device has at least one temperature sensor set up to determine a temperature of the fluid cylinder, where the device has at least one controller unit set up to control the power source or voltage source by closed-loop control as a function of a temperature measured by the temperature sensor.

17. The device according to claim 14, wherein the galvanic insulator includes at least one material selected from the group consisting of ceramic, glassy, glass fiber-reinforced, plastic-like or resin-like materials, an insulating paint, where the galvanic insulator is configured as one or more of the following: a tube, a thin film, a covering, or a layer.

18. The device according to claim 14, wherein the device has at least one outer cylinder, where the outer cylinder is set up to at least partly surround the heating cylinder, where the outer cylinder is set up to galvanically insulate the heating cylinder and to at least partly reduce a loss of heat to the outside.

19. The device according to claim 14, wherein the heating cylinder has a specific electrical resistivity ρ of 1×10⁻⁸Ω m≤ρ≤10⁵Ω m.

20. The device according to claim 14, wherein the heating cylinder and the galvanic insulator have a thermal conductivity k of 10 W/(mK)≤λ≤6000 W/(mK).

21. The device according to claim 14, wherein the heating cylinder has a wall thickness, where the wall thickness of the heating cylinder is less than a wall thickness of the fluid cylinder.

22. The device according to claim 14, wherein the power source and/or voltage source comprises a single-phase or multiphase AC power source and/or a single-phase or multiphase AC voltage source, or a DC power source and/or DC voltage source.

23. The device according to claim 14, wherein the device has a multitude of fluid cylinders, where said device has l fluid cylinders, where l is a natural number not less than two, where said fluid cylinders have symmetric or asymmetric pipes and/or a combination thereof.

24. The device according to claim 14, wherein the feedstock is a hydrocarbon to be subjected to thermal cleavage and/or a mixture.

25. A plant comprising at least one device according to claim 14, wherein the plant is selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

26. A method of heating at least one feedstock using a device according to claim 14 relating to a device, said method comprising the following steps:
providing at least one fluid cylinder for receiving the feedstock and receiving the feedstock in the fluid cylinder;
providing at least one power source and/or at least one voltage source;
generating an electrical current in at least one current-conducting heating cylinder that heats the fluid cylinder by means of Joule heat that arises on passage of the electrical current through the heating cylinder, for heating of the feedstock.
